(19) United States
(12) Patent Application Publication
(10) Pub. No.: US 2009/0040027 A1
(43) Pub. Date: Feb. 12, 2009

(54) RFID System, Power Supply Device and Power Supply Method

(75) Inventor: Toshiyasu Nakao, Tokyo (JP)

Correspondence Address: FOLEY AND LARDNER LLP;SUITE 500, 3000 K STREET NW, WASHINGTON, DC, 20007, US

(73) Assignee: NEC CORPORATION

(21) Appl. No.: 11/887,914

(22) PCT Filed: Apr. 6, 2006
(86) PCT No.: PCT/JP2006/307380

§ 371 Date: Oct. 5, 2007

(30) Foreign Application Priority Data
Apr. 7, 2005 (JP) 2005-110459
Aug. 23, 2005 (JP) 2005-241887

(51) Int. Cl. H04Q 5/22

(52) U.S. Cl. 340/10.5

(57) ABSTRACT

A reader (100) transmits an interrogation wave to a RFID tag (200) through an antenna (102) and receives a response wave from the RFID tag (200). A power supply device (400) generates a power supply wave to be supplied to the RFID tag, based on an instruction from a control means (101), and transmits the power supply wave to the RFID tag (200) while changing the output power of the generated power supply wave. The RFID tag (200) eliminates influences of its position and posture and surely obtains the optimum power supply conditions at least once.

### APPLICABLE FIELD IN THE INDUSTRY

The present invention relates to an RFID system, and more particularly to an RFID system, a power supply device, and a power supply method, which enables an RFID tag to be detected at a high precision by transmitting an interrogation wave and a power supply wave to an RFID tag while changing at least one of a power of the them in transmitting them by employing a plurality of antennas.

### BACKGROUND ART

In an RFID (Radio Frequency Identification) system that is configured of a device for holding an inherent identifier (ID) and a device for reading off it remotely through a radio wave, the system of reading off data of the RFID tag by transmitting a power and a read command to an ID holding device (RFID tag) from a reading device (reader) is called a passive-type RFID system.

FIG. 21 illustrates an example of a general configuration of such an RFID system, and an example of an interrogation wave/a response wave that are exchanged between the reader/the RFID tag, respectively.

In the upper side of FIG. 21, the reader generates an interrogation wave to the RFID tag with encoding/modulation according to a control command from a PC, and transmits it to the RFID tag through an antenna. The interrogation wave is configured of a carrier wave (power supply wave) for playing a role of supplying a power source to the RFID tag, and a modulated portion of the command to the RFID tag. The carrier wave continues to be transmitted for a purpose of supplying the power to the RFID tag even after the command transmission is finished. The RFID tag picks up the power from the carrier wave, and transmits the ID filed in a memory of the RFID tag as a response wave for aiming at expressing an acceptance of the command of the interrogation wave. Upon receipt of the response wave, the reader demodulates/decodes it, thereby to pick up the ID, and delivers it the PC. Such a configuration of the RFID system, which is widely known, is described in details, for example, in Non-patent document 1, etc.

The reader simultaneously carries out the transmission of the interrogation wave and the reception of the response wave, and yet the power of the response wave is as large as only one-several tenth of that of the interrogation wave. For this, the problems that the detection precision of the RFID tag declines due to influences such as an antenna directivity of the RFID tag and the reader, a change in an antenna characteristic caused by matter to which the RFID tag is attached, radio wave interference from the reader or a personal computer that exists in the circumference occurs.

So as to solve this problem, the technique of employing a plurality of the antennas and a plurality of the readers is described in Patent document 1, Patent document 2, Patent document 3, Patent document 4, and Patent document 5.

The system of Patent document 1 includes one transmitting antenna for transmitting a radio signal to the RFID tag connected to an RFID tag transmitting and receiving circuit, a plurality of receiving antennas for receiving the radio signal being coded and being returned from the RFID tag, each of which has been connected to the RFID tag transmitting and receiving circuit, and a decoding circuit for decoding the data returned from the RFID tag by using a plurality of pieces of encoded data received through a plurality of the receiving antennas, and the technique of decoding a signal of the RFID tag from a plurality of pieces of the encoded data received through a plurality of the receiving antennas is described in Patent document 1. This technology, in which the decoding process is realized by using a plurality of pieces of the encoded data received through a plurality of the receiving antennas, is a technology for eliminating a necessity for the receiving level detection circuit, and preventing the detection precision from declining.

In Patent document 2, the technique is described of causing a plurality of the receiving antennas to work synchronously with each other so that the detection areas thereof do not overlap with each other, thereby to avoid a decline in the detection precision due to interference. That is, the system of Patent document 2 is characterized in that the sales method having a customer identification function adopting a radio frequency includes a step of generating electromagnetic fields each having a predetermined operational range adjacent to respective dispensers in plural and independently, and a step of generating a plurality of electromagnetic fields that are synchronized so that each electromagnetic field corresponds to one side of one dispenser, yet a plurality of the electromagnetic fields do not overlap with the first electromagnetic field in terms of the operational range, respectively, and yet a plurality of the electromagnetic fields furthermore do not overlap with the electromagnetic field in the first side of the first dispenser, and the electromagnetic field in the second side of the second dispenser that corresponds to the first side of the first dispenser, respectively

In Patent document 3, a transmission system is described for adjusting and outputting a phase of a signal of the common oscillation source, thereby to optimize the power supply to the RFID tag. This system is characterized in: including an oscillating means for generating a common reference signal that becomes a reference for generating a carrier wave, a plurality of transmitting means for, from an antenna, emitting an output arranged based upon the carrier wave with an identical frequency generated from this reference signal, which becomes a transmission wave, and a controlling means for sending a control signal to each transmitting means to control an operation thereof; that each transmitting means includes a phase adjusting means for receiving the reference signal, shifting the phase thereof, and outputting it, and a sending-out means for, based upon the output of the phase adjusting means and the control signal of the controlling means, supplying the output modulated with the transmission signal to the antenna at the time of making communication, and supplying the output, being only a carrier wave, to the antenna at the time of making no communication; and yet that the phase adjusting means is configured to synchronize the phase of the transmission wave being emitted from the antenna with that of the transmission wave by the other transmitting means.

In Patent document 4, the technique is described of transmitting each of an interrogation wave and a power supply wave from a different antenna, thereby to supply a power to the radio tag (RFID tag). That is, the system of this document, which includes a plurality of the antenna parts, is characterized in being configured to: control each antenna part so that each antenna transmits the first transmission wave of the first frequency band for transmitting a response command and supplying a power to the radio wave tag, and the second transmission wave of the second frequency band for supplying a power to the radio wave tag; supply a power to each radio tag by means of the first transmission wave and the second transmission wave; and surely receive a reply transmission wave by each antenna part.

In Patent document 5, the non-contact information recording medium and gate system including two of the antenna for transmitting a power carrier wave (power supply wave) and the antenna for transmitting a data carrier wave (interrogation wave), which is capable of suppressing interference between the power carrier wave and the data carrier wave at a low level, and yet of realizing miniaturization of the antennas, is described. That is, the system of this document is characterized in that in an automatic ticket examination device, a loop-like power transmission antenna is arranged at prescribed intervals from the upper side of a main body and a loop-like data transmission/reception antenna is arranged almost concentrically with the power transmission antenna in the inner side of the power transmission antenna, and yet in the radio card (RFID tag) side as well, the loop-like data transmission/reception antenna is arranged almost concentrically with a loop-like power reception antenna in the inner side of the loop-like power reception antenna.

Further, as a technique for aiming at enhancing the detection precision of the general RFID system, the diversity antenna technique is utilized of selecting and using the best signal from among the signals received by a plurality of the antennas.
Non-patent document 1: “ALL RADIO WAVE IC TAG”, Nikkei Business Publications, Inc., Apr. 20, 2004, pp. 18-31 and pp. 34-42
Patent document 1: JP-P2004-282522A ✓
Patent document 2: JP3481254B ✓
Patent document 3: JP-P2002-077001A ✓
Patent document 4: JP-P2004-294338A ✓
Patent document 5: JP-P1997-073524A ✓

### DISCLOSURE OF THE INVENTION

### Problems to be Solved by the Invention

The first problem is that there is the case that employment of a plurality of the antennas does not always to lead to an improvement to the detection precision in the RFID system.

The reason is that the conventional RFID system assumes a mode in which data is acquired among from the signals received by a plurality of the antennas by making a reference to the best intensity and decoding result, which is equivalent to simply summing up pieces of data obtained by independently utilizing each antenna. There is the possibility that the RFID tag that cannot be detected by each antenna still exists because no detection precision changes in the read operation employing each antenna.

The second problem is that there is the case that, in simultaneously reading off a plurality of the RFID tags, employment of a plurality of the antennas does not always to lead to an improvement to the detection precision.

The reason is that there is the case that in simultaneously reading off a plurality of the RFID tags, in the conventional RFID system, the power supply wave and interrogation wave with a fixed magnitude or phase are simultaneously transmitted from a plurality of the antennas, whereby the magnitude of the power that the RFID tag receives differs depending upon a position or posture of the RFID tag, and hence the power, of which the magnitude is optimum in order for all of the RFID tags to work, is not always obtained.

The present invention has been accomplished in consideration of the above-mentioned problems, and an object thereof is to provide a technology capable of enhancing the detection precision of the RFID tag.

Further, another object of the present invention is to provide a technology capable of eliminating influences of the position and the posture of the RFID tag, and surely producing the power supply condition optimum for the RFID tag at least once.

### Means for Solving the Problems

The 1st invention for solving the above-mentioned task, which is an RFID system, characterized in being configured to transmit an interrogation wave being transmitted to an RFID tag and a power supply wave being transmitted to the RFID tag while changing a power of at least one of them.

The 2nd invention for solving the above-mentioned problem, in the above-mentioned 1st invention, is characterized in periodically changing the power of one of the interrogation wave being transmitted to the RFID tag and the power supply wave being transmitted to the RFID tag.

The 3rd invention for solving the above-mentioned problem, in the above-mentioned 1st or 2nd inventions, is characterized in transmitting the interrogation wave being transmitted to the RFID tag and the power supply wave being transmitted to the RFID tag by changing the power of one of them in a descending order.

The 4th invention for solving the above-mentioned problem, in the above-mentioned 1st or 2nd inventions, is characterized in transmitting the interrogation wave being transmitted to the RFID tag and the power supply wave being transmitted to the RFID tag by changing the power of one of them in an ascending order.

The 5th invention for solving the above-mentioned task, which is an RFID system, characterized in comprising: a reader comprising an interrogation wave power adjusting means for adjusting a power of an interrogation wave being transmitted to an RFID tag, and a transmitting means for transmitting the power-adjusted interrogation wave to the RFID tag; a power supply device comprising a power supply wave power adjusting means for adjusting a power of a power supply wave being transmitted to an RFID tag, and a transmitting means for transmitting the power-adjusted power supply wave to the RFID tag; and a controlling means for controlling at least one of said interrogation wave power adjusting means and said power supply wave power adjusting means, which transmits the wave while changing its power.

The 6th invention for solving the above-mentioned problem, in the above-mentioned 5th invention, is characterized in that said controlling means changes the power periodically.

The 7th invention for solving the above-mentioned problem, in the above-mentioned 5th or 6th inventions, is characterized in that said controlling means changes the power in a descending order.

The 8th invention for solving the above-mentioned problem, in the above-mentioned 5th or 6th inventions, is characterized in that said controlling means changes the power in an ascending order.

The 9th invention for solving the above-mentioned task, which is a reader in an RFID system, characterized in comprising: a power adjusting means for changing a power of an interrogation wave being transmitted to an RFID tag; and a transmitting means for transmitting the power-adjusted interrogation wave to the RFID tag.

The 10th invention for solving the above-mentioned problem, in the above-mentioned 9th invention, is characterized in comprising a controlling means for controlling a power adjustment of said power adjusting means.

The 11th invention for solving the above-mentioned problem, in the above-mentioned 10th invention, is characterized in that said reader is a portable reader.

The 12th invention for solving the above-mentioned task, which is a power supply device of an RFID system, characterized in comprising: a power adjusting means for adjusting a power of a power supply wave being transmitted to an RFID tag; and a transmitting means for transmitting the power-adjusted power supply wave to the RFID tag.

The 13th invention for solving the above-mentioned problem, in the above-mentioned 12th invention, is characterized in comprising a controlling means for controlling a power adjustment of said power adjusting means.

The 14th invention for solving the above-mentioned task, which is a control program of an RFID system, characterized in causing an information processing device to execute a process of changing a power of at least one of an interrogation wave being transmitted to an RFID tag, and a power supply wave being transmitted to an RFID tag.

The 15th invention for solving the above-mentioned problem, in the above-mentioned 14th invention, is characterized in that the process of changing the power is a process of periodically changing the power.

The 16th invention for solving the above-mentioned problem, in the above-mentioned 14th or 15th inventions, is characterized in that the process of changing the power is a process of changing the power in a descending order.

The 17th invention for solving the above-mentioned problem, in the above-mentioned 14th or 15th inventions, is characterized in that the process of changing the power is a process of changing the power in an ascending order.

The 18th invention for solving the above-mentioned task, which is a power supply method of supplying a power to an RFID tag, characterized in transmitting an interrogation wave being transmitted to an RFID tag and a power supply wave being transmitted to the RFID tag while changing a power of at least one of them.

The 19th invention for solving the above-mentioned problem, in the above-mentioned 18th invention, is characterized in periodically changing the power of one of the interrogation wave being transmitted to the RFID tag and the power supply wave being transmitted to the RFID tag.

The 20th invention for solving the above-mentioned problem, in the above-mentioned 18th or 19th inventions, is characterized in transmitting the interrogation wave being transmitted to the RFID tag and the power supply wave being transmitted to the RFID tag by changing the power of one of them in a descending order.

The 21st invention for solving the above-mentioned problem, in the above-mentioned 18th or 19th inventions, is characterized in transmitting the interrogation wave being transmitted to the RFID tag and the power supply wave being transmitted to the RFID tag by changing the power of one of them in an ascending order.

In the present invention, the interrogation wave, which is configured of a carrier wave (power supply wave) for playing a role of supplying a power source to the RFID tag and a modulated portion of a command to the RFID tag, and a power supply wave for supplying a power source to the RFID tag are transmitted to the RFID tag by simultaneously utilizing a plurality of the antennas. And, the present invention is characterized in transmitting the interrogation wave and the power supply wave while changing the power of at least one of them in transmitting them.

### EFFECT OF THE INVENTION

The present invention can provide the RFID system capable of enhancing the detection precision of the RFID tag. The reason is that transmitting the interrogation wave and the power supply wave while changing the power of at least one of them makes it possible to eliminate influences of the position and the posture of the RFID tag, and to surely produce the power supply condition optimum for each RFID tag at least once.

Further, the present invention realizes the power saving of the reader, yet can provide the reader capable of enhancing the detection precision of the RFID tag, and particularly, takes conspicuous effect for the device being operated with a battery, for example, a portable reader. The reason is that it becomes possible for the portable reader to detect the RFID tag at a high precision without being influenced by the posture and the position of the RFID tag 200 existing in each matter because the power supply wave is supplied besides the interrogation wave, and in addition hereto, the interrogation wave and the power supply wave are transmitted while the power of at least one of them is changed.

### BRIEF DESCRIPTION OF THE DRAWINGS

FIG. 1 is an appearance view of the RFID system in a first embodiment.

FIG. 2 is a block diagram of the RFID system in the first embodiment.

FIG. 3 is a view for explaining a flow of the process of the first embodiment.

FIG. 4 is a view for explaining an operation of the first embodiment.

FIG. 5 is a view for explaining an operational principle of the first embodiment.

FIG. 6 is a configuration view of an experimental system for measuring an effect of an improvement to the detection precision in the case that a reader 100 reads off a plurality of RFID tags 200 fixed to a plastic-made tray.

FIG. 7 is a graph illustrating a measurement result of the experimental system for measuring an effect of an improvement to the detection precision in the case that a reader 100 reads off a plurality of RFID tags 200 fixed to a plastic-made tray.

FIG. 8 is a graph illustrating a measurement result of the experimental system for measuring an effect of an improvement to the detection precision in the case that a reader 100 reads off a plurality of RFID tags 200 fixed to a plastic-made tray.

FIG. 9 is a graph illustrating a measurement result of the experimental system for measuring an effect of an improvement to the detection precision employing FIG. 6.

FIG. 10 is a view illustrating an example of a performance of a tolerable interference power of the reader.

FIG. 11 is a block diagram of the RFID system in a second embodiment.

FIG. 12 is a view for explaining a flow of the process of the second embodiment.

FIG. 13 is a view for explaining an operation of the second embodiment.

FIG. 14 is an appearance view of the RFID system in a third embodiment.

FIG. 15 is a block diagram of the RFID system in a third embodiment.

FIG. 16 is a view for explaining a flow of the process of the third embodiment.

FIG. 17 is a view for explaining an operation of the third embodiment.

FIG. 18 is a block diagram of the RFID system in a fourth embodiment.

FIG. 19 is a block diagram of the RFID system in a fifth embodiment.

FIG. 20 is a block diagram of the RFID system in a sixth embodiment.

FIG. 21 is a view illustrating an example of a general configuration of the RFID system.

FIG. 22 is a system appearance view of an example 2.

FIG. 23 is a view illustrating a configuration of an experimental system for measuring a relation of a detection precision at which the reader 100 reads off the RFID tag, an output power of the reader 100, and an output power of a power supply device 400 in the case of having carried ten RFID tags 200 fixed to an acrylic-made tray at a speed of 120 m/minute.

FIG. 24 is a graph illustrating a measurement result of the experimental system for measuring a relation of a detection precision at which the reader 100 reads off the RFID tag, an output power of the reader 100, and an output power of a power supply device 400 in the case of having carried ten RFID tags 200 fixed to an acrylic-made tray at a speed of 120 m/minute.

FIG. 25 is a graph illustrating a measurement result of the experimental system for measuring a relation of a detection precision at which the reader 100 reads off the RFID tag, an output power of the reader 100, and an output power of a power supply device 400 in the case of having carried ten RFID tags 200 fixed to an acrylic-made tray at a speed of 120 m/minute.

FIG. 26 is an appearance view of an example 3.

FIG. 27 is a view for explaining how a controlling means 101 controls the output power of the reader 100 and the outputs from an antenna 102 and an antenna 406 connected to the power supply device 400 in this example.

### DESCRIPTION OF NUMERALS

100 reader
101 controlling means
102 and 406 antennas
104 modulating/demodulating means
105 encoding/decoding means
200 RFID tag
300 external device
400 power supply device
407 power adjusting means
408 power supply wave generating means

### BEST MODE FOR CARRYING OUT THE INVENTION

Next, the best mode for carrying out the present invention will be explained in details by making a reference to the accompanied drawings.

### First Embodiment

A first embodiment will be explained.

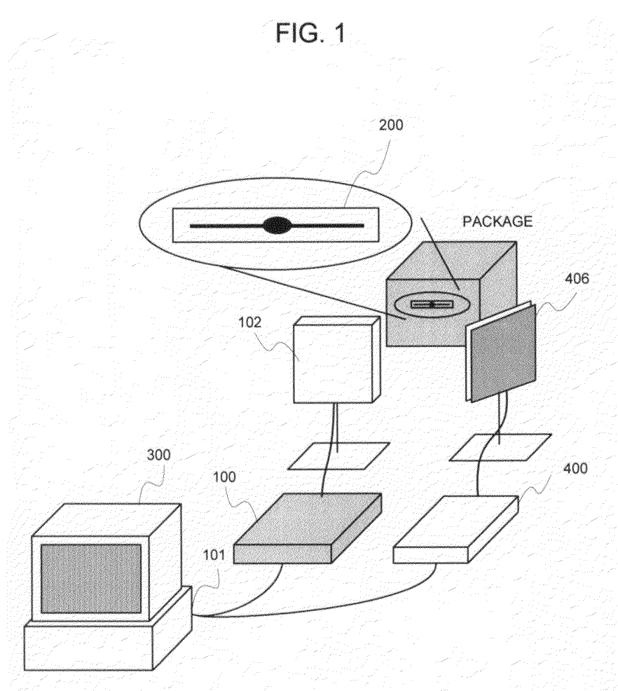

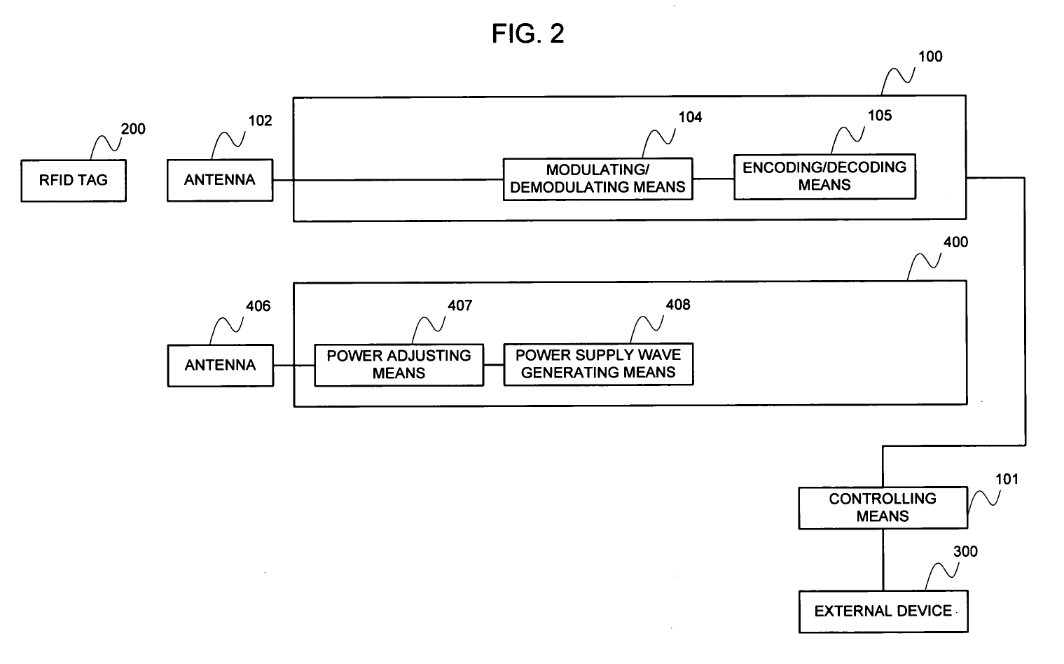

FIG. 1 is an appearance view of the RFID system in the first embodiment, and FIG. 2 is a block diagram of the RFID system in the first embodiment.

The RFID system in the first embodiment, as shown in FIG. 1, is configured of an RFID tag 200 for holding an ID attached to a package etc., receiving an interrogation wave from an antenna 102 and a power supply wave from an antenna 406, respectively, and transmitting an ID filed inside it as a response wave, a controlling means 101 for controlling an operation of each portion of a reader 100, an external device 300 for giving instruction to the controlling means 101, the reader 100 for transmitting the interrogation wave to the RFID tag 200, or reading off the response wave from the RFID tag 200 through the antenna 102, the antenna 102 for transmitting the interrogation wave from the reader 100, or receiving the response wave from the RFID tag 200, an antenna 406 for transmitting the power supply wave to the RFID tag 200, and a power supply device 400 for supplying the power to the RFID tag 200 through the antenna 406. Additionally, in the present invention, the so-called interrogation wave signifies a wave that is configured of a carrier wave for playing a role of supplying a power source to the RFID tag, and a modulated portion of a command to the RFID tag, and the so-called power supply wave signifies a carrier wave for playing a role of supplying a power source to the RFID tag.

The reader 100, as shown in FIG. 2, is configured of a encoding/decoding means 105 for generating a code, which is transmitted to the RFID tag 200, to convey it to a modulating/demodulating means 104, and yet picking up data from the demodulated signal, which is output from the modulating/demodulating means 104, and the modulating/demodulating means 104 for modulating the encoded signal from the encoding/decoding means 105 to convey it to the antenna 102 based upon the instruction by the controlling means 101, and yet demodulating the response wave from the RFID tag 200, which is output from the antenna 102, to transmit it to the encoding/decoding means 105.

The power supply device 400, as shown in FIG. 2, is configured of a power supply wave generating means 408 for generating a power supply wave, which is supplied to the RFID tag, based upon the instruction by the controlling means 101, and a power adjusting means 407 for adjusting an output power of the power supply wave generated by the power supply wave generating means 408. In the first embodiment, the power supply device 400 operates without synchronizing with the reader 100; however a configuration may be made so that the power supply device 400 and the reader 100 are synchronized with each other for operation. Additionally, an example in which the power supply device 400 and the reader 100 are synchronized with each other for operation will be described later.

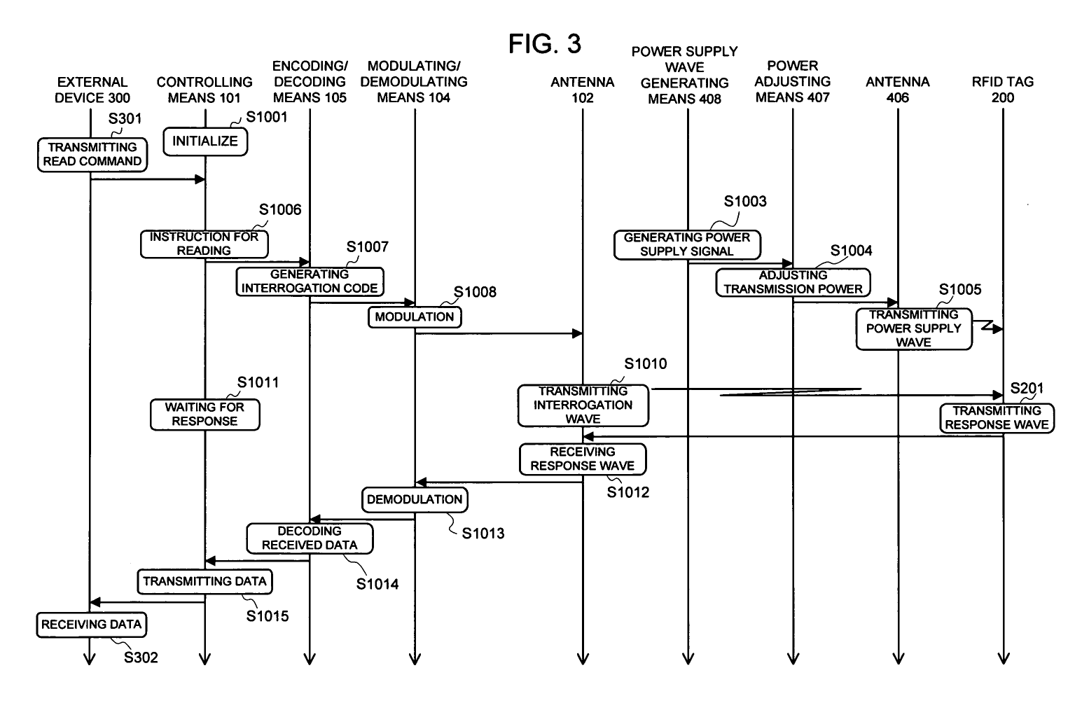

Next, a flow of the process of the first embodiment of the present invention will be explained by employing FIG. 3.

At first, after the controlling means 101 initializes the entirety of the reader 100 (S1001), it waits for a command from the external device 300. And, upon receipt of a read command from the external device 300 (S301), the controlling means 101 sends an instruction to the encoding/decoding means 105 so that the encoding/decoding means 105 generates an interrogation wave for the RFID tag (S1006).

After the encoding/decoding means 105 generates a code for a command, which is forwarded to the RFID tag, upon receipt of the instruction (S1007), and generates an interrogation wave by applying the modulation necessary for transmission, which is carried out by the modulating/demodulating means 104, hereto (S1008), it transmits the interrogation wave with a predetermined power through the antenna 102 (S1010).

Thereafter, the controlling means 101 comes into a situation of waiting for a response wave from the RFID tag (S1011).

On the other hand, the power supply device 400 generates a power supply signal by the power supply wave generating means 408 (S1003) in parallel to the transmission of the interrogation wave by the reader 100. The power supply device 400 transmits the power supply wave to the RFID tag 200 through the antenna 406 (S1005) while periodically changing the power of the power supply signal by the power adjusting means 407 (S1004). Herein, the so-called power supply wave is a carrier wave similar to the power supply portion of the foregoing interrogation wave that is successively transmitted.

The RFID tag 200 receives the interrogation wave and transmits the ID filed inside the RFID tag 200 as a response wave responding to the superposed code for a command (S201).

Upon receipt the response wave from the antenna 102 (S1012), the reader 100 executes each of the demodulating process by the modulating/demodulating means 104, and the decoding process by the encoding/decoding means 105 (S1013 and S1014), picks up the ID, which is included in the response wave, as data, and transmits it to the external device 300 (S1015).

The external device 300 executes a displaying process, a computing process, etc. based upon the data received from the reader 100 (S302).

The controlling means 101 repeats the process of the step S1002 and the step after it and continues to execute the ID reading process of the RFID tag 200 until it receives an instruction for interrupting the process from the external device 300. During this time, the power supply device 400 continues to supply the power supply wave to the RFID tag 200 while changing the power of the power supply wave.

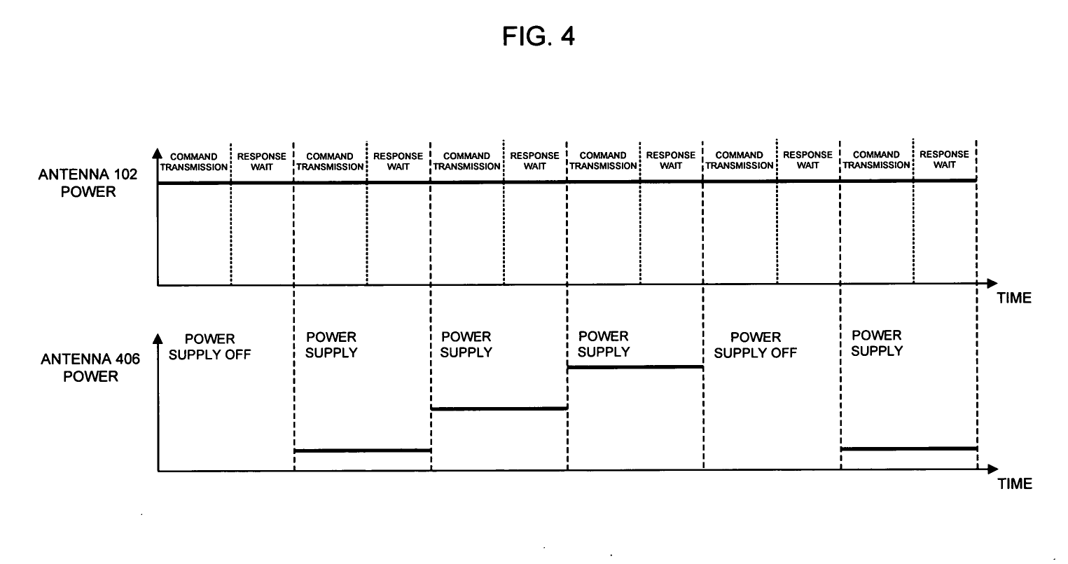

FIG. 4 is a view for explaining an operation of the first embodiment of the present invention.

In FIG. 4, the power of the interrogation wave being transmitted from the antenna 102, and an operational timing of the command transmission/response wait are illustrated in the upper stage, and the power of the power supply wave being transmitted from the antenna 406 to the RFID tag 200 is illustrated in the lower side.

As shown in FIG. 4, in the first embodiment of the present invention, the interrogation wave is provided successively from the antenna 102, the reader 100 repeats the situation of transmitting the command and waiting for the response for execution. On the other hand, the power supply wave, of which the power continues to change in a manner of augmenting in an ascending order, beginning with the situation of the power supply off, is transmitted from the antenna 406 connected to the power supply device 400.

That is, the first embodiment of the present invention is characterized in that the interrogation wave is successively provided from the antenna 102, the reader 100 repeats the situation of transmitting the command and waiting for the response transmission for execution, whereas the power supply wave, of which the power continues to change, is supplied from the antenna 406.

Next, an effect of the embodiment of the present invention will be explained.

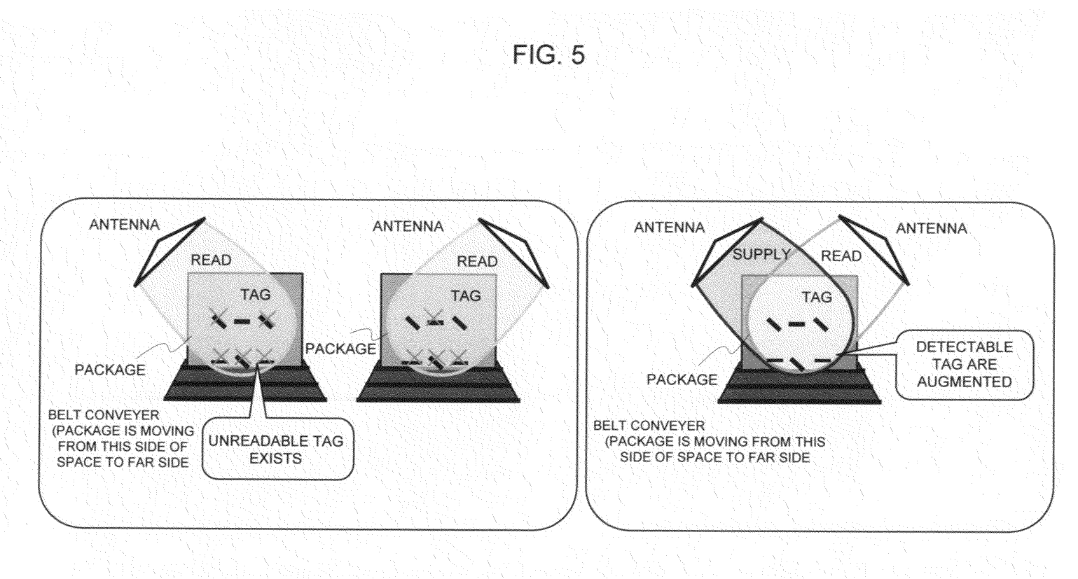

FIG. 5 is a view for explaining an operational principle of the first embodiment of the present invention.

The RFID tag, which exhibits an excellent detection precision for the interrogation wave received frontally, exhibits a deteriorated detection precision for the interrogation wave, which arrives obliquely, due to directivity of its antenna, or in a case where there exists an obstacle between the antenna and the RFID tag. For example, as shown in the left side of FIG. 5, in a case where the RFID tag in a box, which is put on a belt conveyer and migrates, assumes various postures, it follows that the undetectable RFID tag is generated depending upon the distance from the antenna transmitting the interrogation wave or the posture of the RFID tag. Even though the posture of the antenna is changed, it is difficult for the antenna to assume an excellent posture for all of the RFID tags, and besides, the antenna posture is changed whenever the position/posture of the RFID tag in a box changes, whereby there is the possibility that the RFID tag, which cannot be detected by each antenna, still exists.

The present invention is characterized in that, as shown in the right side of FIG. 5, by transmitting the interrogation wave to the RFID tag (by executing a read operation), and simultaneously therewith, by transmitting the power supply wave from the another antenna, the sufficient power is supplied to the RFID tag, thereby enhancing the detection precision of the RFID tag. That is, simultaneously transmitting the interrogation wave and the power supply wave from a plurality of the antennas each of which exists at a different position makes it possible to detect the tag as well, which assumes the position/posture difficult for detecting with a single antenna, thereby enhancing the detection precision of the reader.

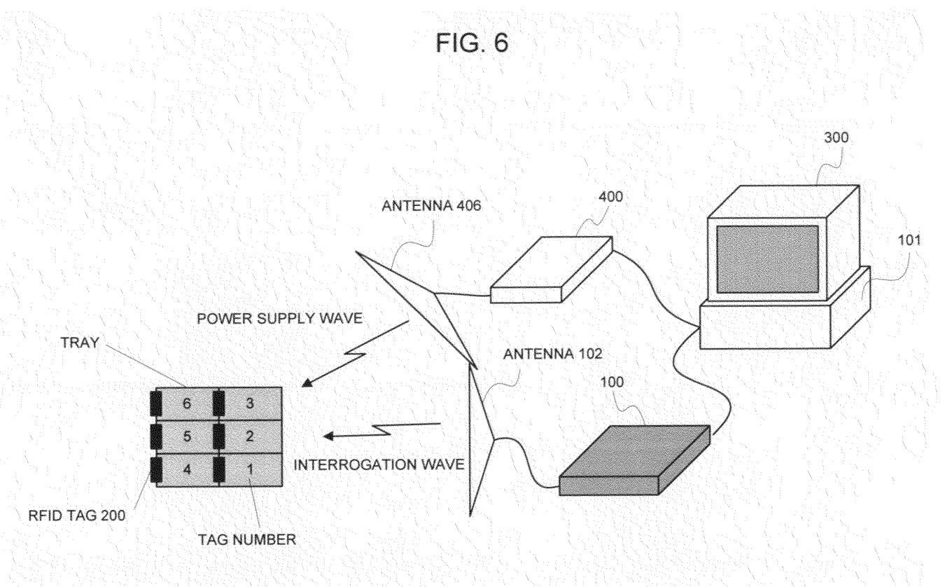

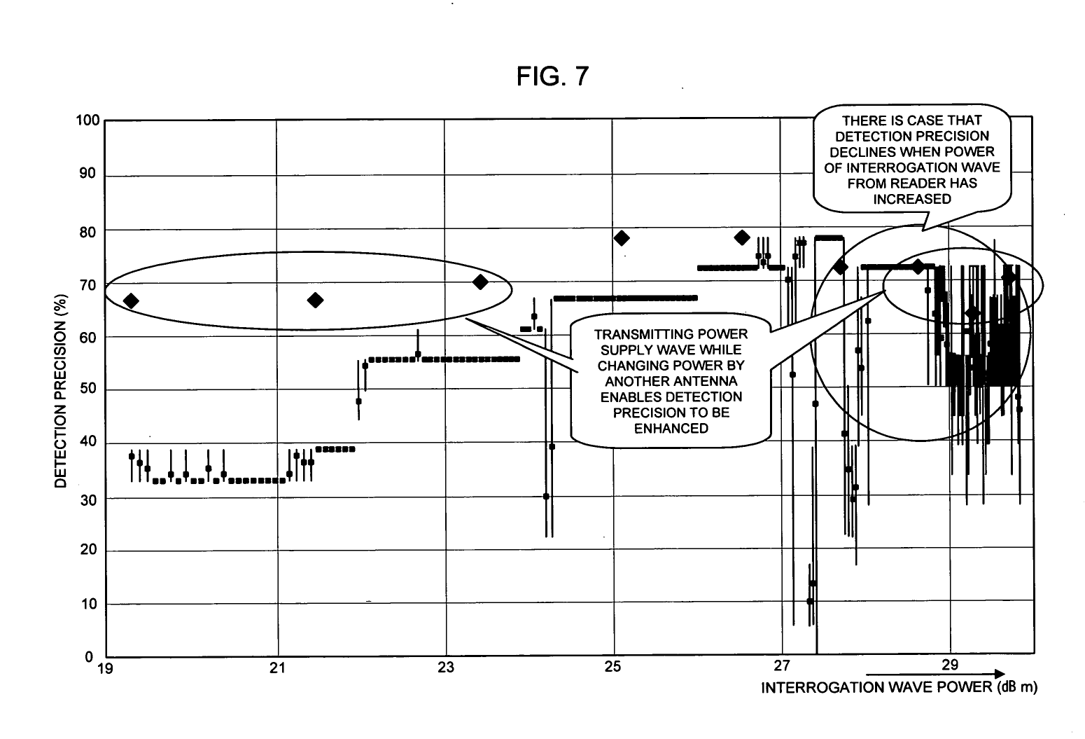

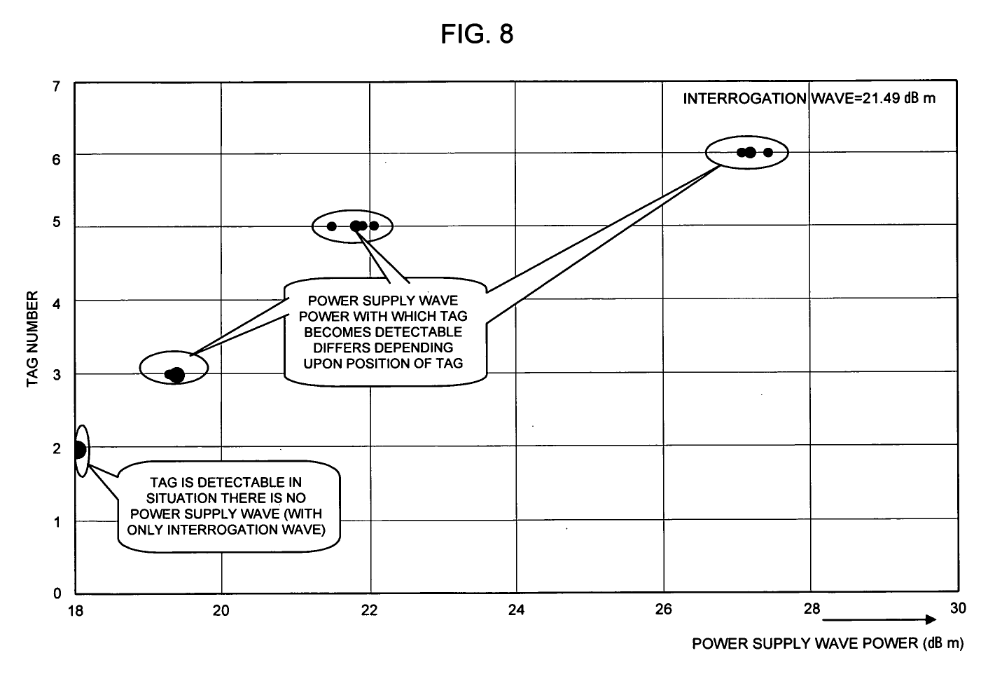

FIG. 6 is a configuration view, and each of FIG. 7 and FIG. 8 is a graph illustrating a measurement result of an experimental system for measuring an effect of an improvement to the detection precision in the case that the reader 100 reads off a plurality of the RFID tags 200 fixed to a plastic-made tray. Additionally, in FIG. 6, the control line, which is input into the power supply device 400 from the controlling means 101, is a control line for the experiment, and this does not deviate from the scope of this embodiment. Further, the control line to the power supply device 400 from the controlling means 101 also can be adopted for a purpose of a synchronous operation of the power supply device 400 and the reader 100.

In FIG. 7, the power of the interrogation wave being output from the reader 100, and the detection precision are shown in a traverse axis and a longitudinal axis, respectively. Each of rectangular points indicates an average detection precision in each power of the interrogation wave being transmitted from the antenna 102 of the reader 100, and bars in the upper and lower sides indicate a distribution range. It can be confirmed from FIG. 7 that the detection precision at the point of the maximum power, i.e. in the neighborhood of the right end of the graph declines as compared with the detection precision at a point just before, which indicates that supplying the excessive power to the RFID tag produces an reverse effect from a viewpoint of the detection precision in some cases.

It is difficult to pre-measure such a decline in the detection precision due to excessive/shortage in the power supply to the RFID tag because a probability as to whether it occurs changes depending upon a positional relation of the RFID tag and each of the antenna 102 and the antenna 406, or the surrounding situation.

FIG. 8 is a graph illustrating the detection precision in the case that the power supply device 400 simultaneously has transmitted the power supply wave while changing the power of the power supply wave, as shown in FIG. 4, at the moment that the reader 100 has transmitted the interrogation wave with a fixed magnitude, and the power of the power supply wave being output from the power supply device 400 and the tag number of the tag affixed to the tray are shown in a traverse axis and a longitudinal axis, respectively. Further, a size of the painted-over circle on the graph indicates the detection precision of the tag, and the circle, which exists in the left end of the graph, indicates that the tag is detectable even though no power supply wave exists.

FIG. 8 indicates that the tag having the tag number 2 is detectable even in case where no power supply wave exists, and the tags having the tag numbers 3, 5, and 6 become detectable only if they are given the power supply wave, and yet differ from each other in the magnitude of the power supply wave with which the tag becomes detectable.

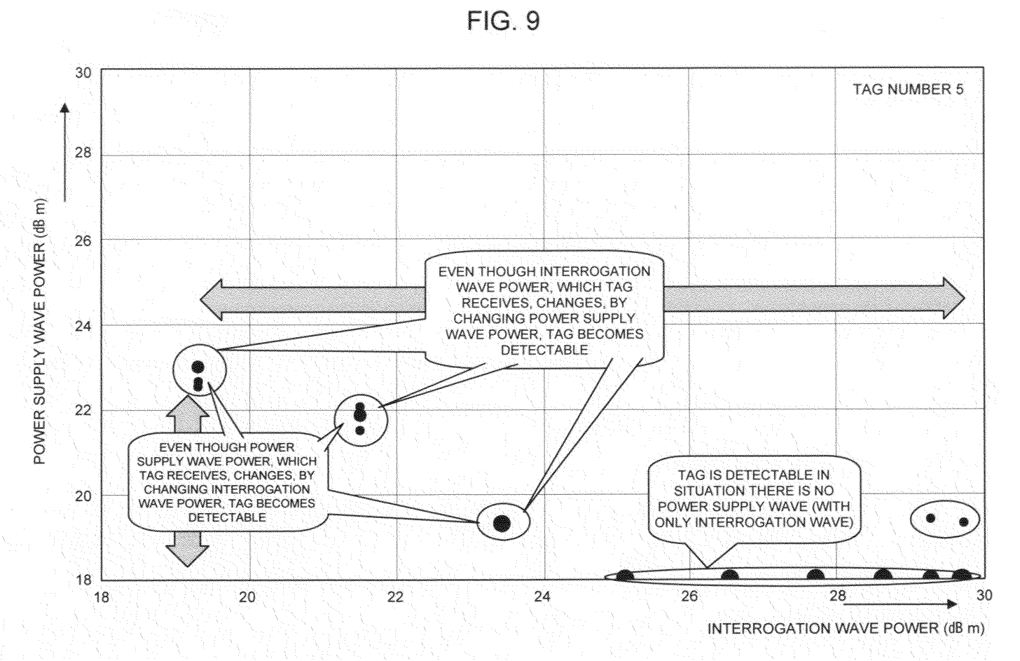

FIG. 9, similarly to FIG. 8, is a graph illustrating a measurement result of the experimental system for measuring an effect of an improvement to the detection precision employing FIG. 6.

FIG. 9 is a graph illustrates a relation of the magnitude of the interrogation wave being output from the reader 100, the magnitude of the power supply wave being output from the power supply device 400, and the detection precision with regard to the tag number 5, in which the power of the interrogation wave being output from the reader 100 and the power of the power supply wave being output from the power supply device 400 are shown in a traverse axis and a longitudinal axis, respectively, and the size of the painted-over circle indicates the detection precision of the tag. The painted-over circle, which exists in the lower end of the graph, indicates that the tag is detectable even though no power supply wave exists.

This embodiment is characterized in that the interrogation wave with a fixed magnitude is output, whereas the power supply wave is output while its magnitude is changed. It is thinkable that even though the magnitude of the output of the interrogation wave from the reader 100 is a constant, the power of the interrogation wave, which is receivable by the tag, is changed depending upon the position and the posture of the tag. FIG. 9 indicates that also in a case where the magnitude of the interrogation wave received by the tag differs due to such influences of the position and the posture, executing an read operation while periodically changing the power of the power supply wave makes it possible to enhance the detection precision.

This embodiment of the present invention is characterized in that executing an read operation while periodically changing the power of the power supply wave in such a manner makes it possible to eliminate influences of the position and the posture of the RFID tag, and to surely produce the power supply condition optimum for each RFID tag at least once.

Additionally, a step number, a period, and a change pattern of the power of the power supply wave should be set responding to the reader being utilized and the surrounding environment. For example, in a case where a relatively high power supply is considered to be necessary for the RFID tag, it is enough that the output of the power supply wave is changed in a descending order, and contrarily, in a case where only the relatively low power supply is necessary, changing the output of the power supply wave in the ascending order of the power makes it possible to obtain an effect of the detection precision owing to the power supply in a shorter time.

Further, in a case where the reader has a low degree of the tolerable interference power, the problem that the demodulating process or the decoding process does not work well when the power supply wave is input from the antenna for an interrogation wave, and hence the RFID tag cannot be totally detected occurs sometimes. In this case, making setting so that the carrier frequency of the power supply wave and that of the interrogation wave do not overlap with each other makes it possible to alleviate an influence of the interference power.

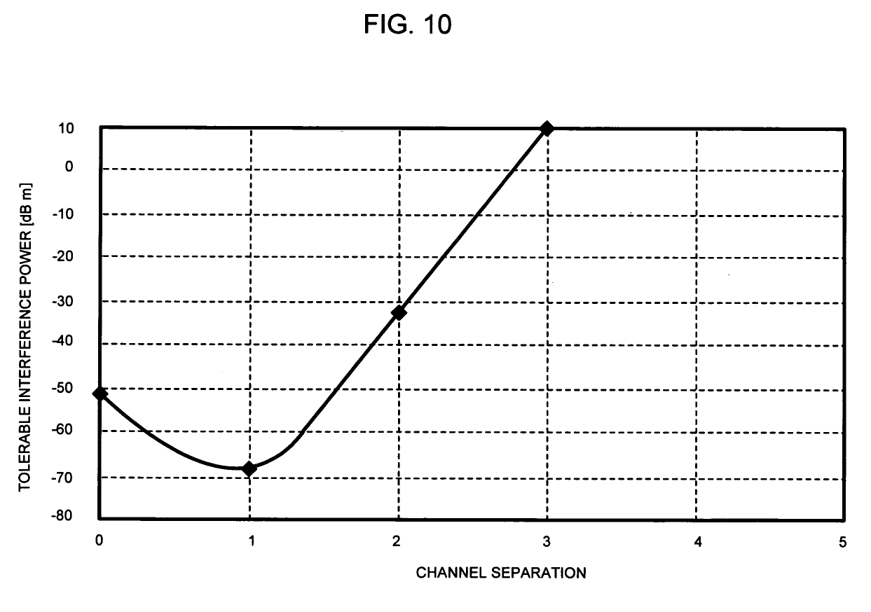

FIG. 10 is a view illustrating an example of a performance of the tolerable interference power of the reader, in which the traverse axis assumes a channel separation of the carrier frequency, and the longitudinal axis assumes a minimum interference power amount with which the reader becomes non-operative. FIG. 10 shows that widening the channel separation allows a performance of the tolerable interference power to be enhanced. As a rule, the RFID tag, which is not provided with a frequency filter, is configured so that it can utilize the signal having a wide-band frequency as a carrier wave, so the effect of the power supply in the present invention is maintained even though the carrier frequency is altered,

Further, the antennas each of which exists at a different position are utilized for different roles, i.e. the transmission of the interrogation wave and the transmission of the power supply wave, whereby the present invention takes conspicuous effect of the improvement to the detection precision in particular in a case where the postures of the RFID tags are dispersed.

Further, the power of the interrogation wave being transmitted from the single antenna is not increased, but the power is increased only in the neighborhood of the RFID tag, being an object of detection, by combining the outputs from a plurality of the antennas, whereby an influence of leakage of the radio wave into the neighborhood becomes small, and a decline as well in the detection precision due to the interference between the readers can be avoided.

### Second Embodiment

A second embodiment of the present invention will be explained.

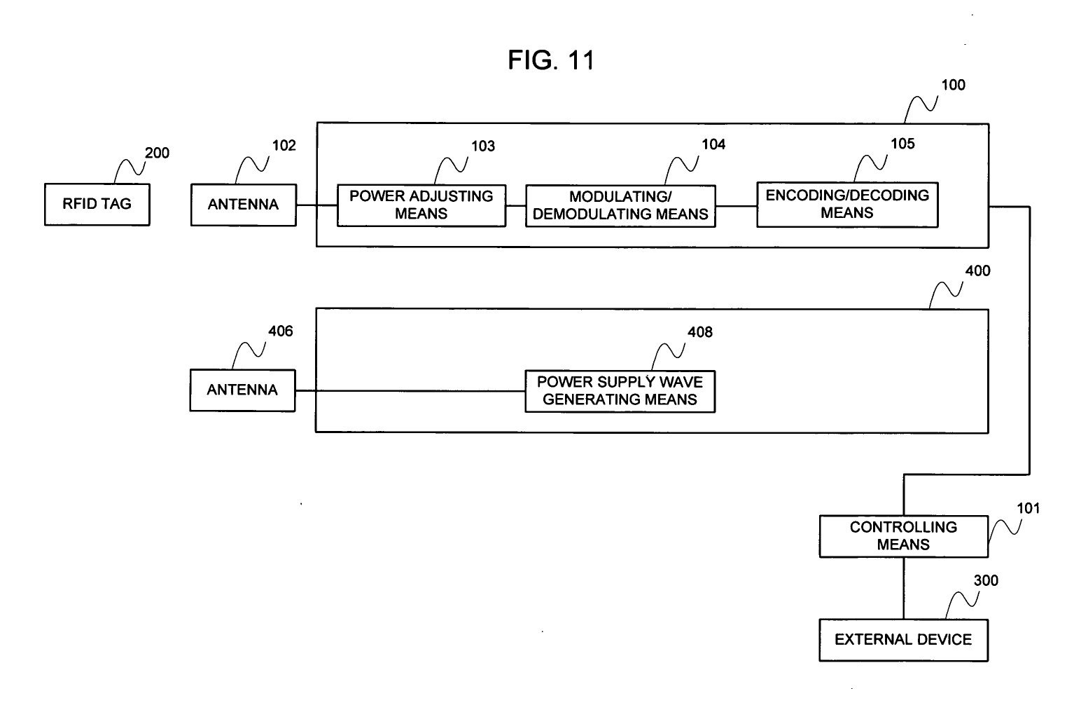

The power of the power supply wave for supplying the power to the RFID tag 200 was changed in the first embodiment, and the power of the interrogation wave being transmitted to the RFID tag 200 is changed in the second embodiment, which differs from the first embodiment. Thereupon, as shown in FIG. 11, a power adjusting means 103 for adjusting a power of an interrogation wave is mounted onto the reader 100 instead of eliminating the power adjusting means 407 of the power supply device 400. Additionally, similarly to the first embodiment, the power supply device 400 and the reader 100 are not synchronized with each other for operation; however a configuration may be made so that the power supply device 400 and the reader 100 are synchronized with each other for operation.

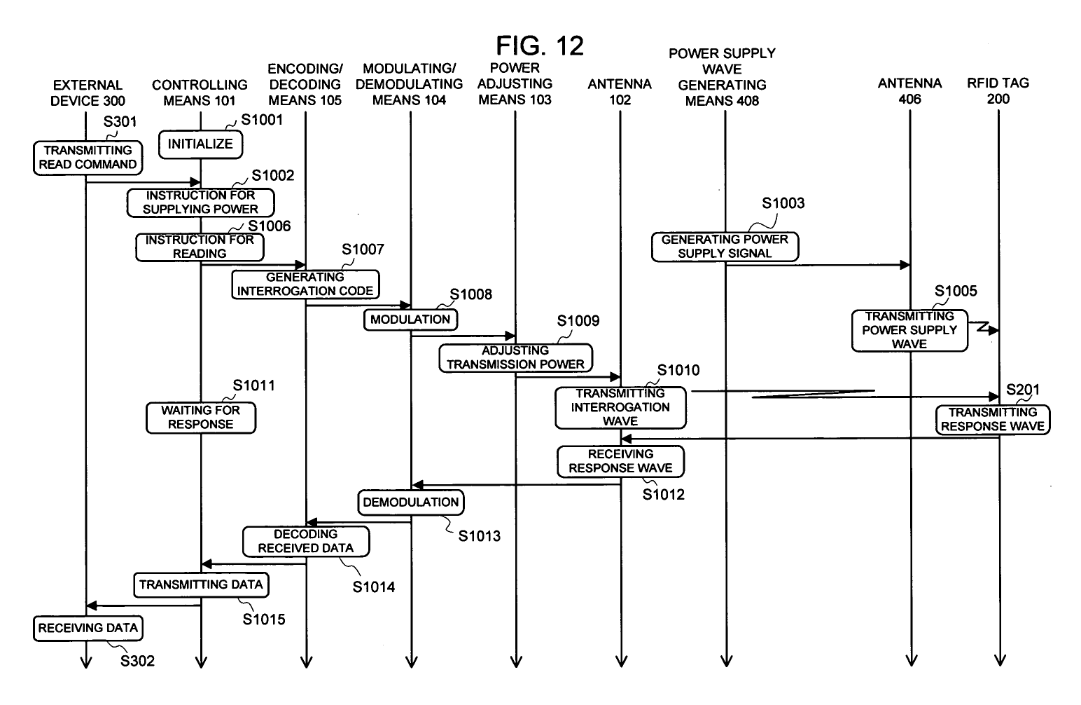

Next, a flow of the process of the second embodiment of the present invention will be explained by employing FIG. 12.

At first, after the controlling means 101 initializes the entirety of the reader 100 (S1001), it waits for a command from the external device 300. And, upon receipt of a read command from the external device 300, the controlling means 101 sends an instruction to the encoding/decoding means 105 so that the encoding/decoding means 105 generates an interrogation wave to the RFID tag (S1006).

After the encoding/decoding means 105 generates a code for a command, which is to be forwarded to the RFID tag, upon receipt of the instruction (S1007), and the modulating/demodulating means 104 applies the modulation necessary for transmission for it, thereby to generate an interrogation wave (S1008), the power adjusting means 103 adjusts the power of this interrogation wave (S1009). And the power-adjusted interrogation wave is transmitted to the RFID tag through the antenna 102 (S1010).

Thereafter, the controlling means 101 comes into a situation of waiting for a response wave from the RFID tag (S1011).

On the other hand, the power supply device 400 generates a power supply signal by the power supply wave generating means 408 (S1003) in parallel to the transmission of the interrogation wave by the reader 100. And, the power supply device 400 transmits the power supply wave to the RFID tag 200 through the antenna 406 (S1005). Herein, the so-called power supply wave is a carrier wave similar to the power supply portion of the interrogation wave that is successively transmitted.

The RFID tag 200 receives the interrogation wave and transmits the ID filed inside the RFID tag 200 as a response wave responding to the superposed code for a command (S201).

Upon receipt of the response wave from the antenna 102 (S1012), the reader 100 executes each of the demodulating process by the modulating/demodulating means 104, and the decoding process by the encoding/decoding means 105 (S1013 and S1014), picks up the ID, which is included in the response wave, as data, and transmits it to the external device 300 (S1015).

The external device 300 executes a displaying process, a computing process, etc. based upon the data received from the reader 100 (S302).

The controlling means 101 repeats the process of the step S1002 and the step after it and continues to execute the ID reading process of the RFID tag 200 until it receives an instruction for interrupting the process from the external device 300. During this time, the power supply device 400 continues to supply the power supply wave to the RFID tag 200.

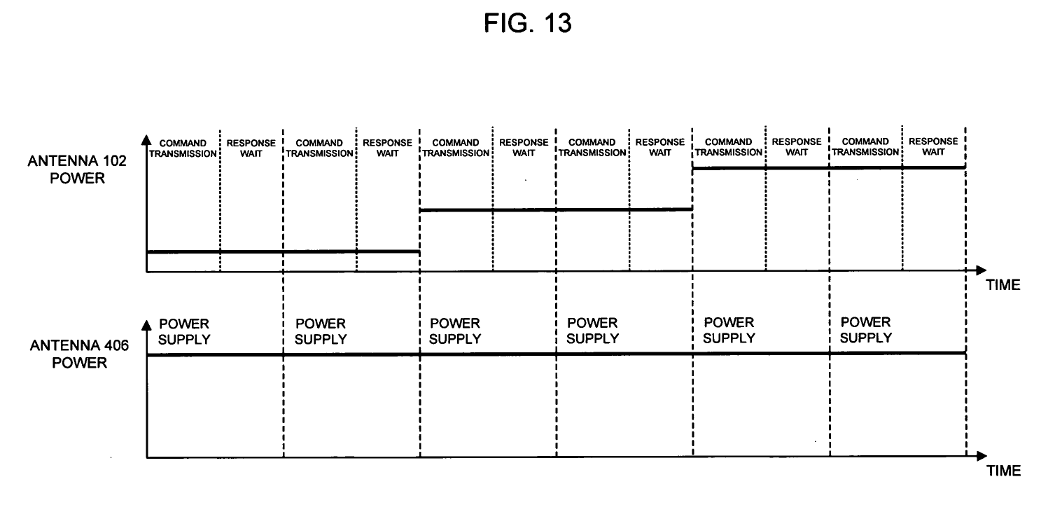

FIG. 13 is a view for explaining an operation of the second embodiment of the present invention.

In FIG. 13, the power of the interrogation wave being transmitted from the antenna 102, and the operational timing of the command transmission/the response wait are shown in the upper stage, and the power of the power supply wave, which is transmitted from the antenna 406 to the RFID tag 200, is shown in the lower stage.

As shown in FIG. 13, in the second embodiment of the present invention, the interrogation wave is successively provided from the antenna 102, and the reader 100 changes the power of the interrogation wave while repeating the situation of transmitting the command and waiting for the response transmission for execution. On the other hand, the power supply wave is transmitted from the antenna 406 connected to the power supply device 400.

Next, an effect of the embodiment of the present invention will be explained.

The second embodiment is characterized in that the power supply wave having a fixed magnitude is output, whereas the interrogation wave is output while its magnitude is changed. It is thinkable that even though the magnitude of the output of the power supply wave from the power supply device 400 is constant, the power of the power supply wave, which is receivable by the tag, is changed depending upon the position and the posture of the tag. FIG. 9 indicates that also in a case where the power of the power supply wave received by the tag differs due to such influences of the position and the posture, executing an read operation while periodically changing the power of the interrogation wave makes it possible to enhance the detection precision.

This embodiment of the present invention is characterized in that executing an read operation while periodically changing the power of the interrogation wave in such a manner makes it possible to eliminate influences of the position and the posture of the RFID tag, and to produce the power supply condition optimum for each RFID tag at least once.

### Third Embodiment

A third embodiment will be explained.

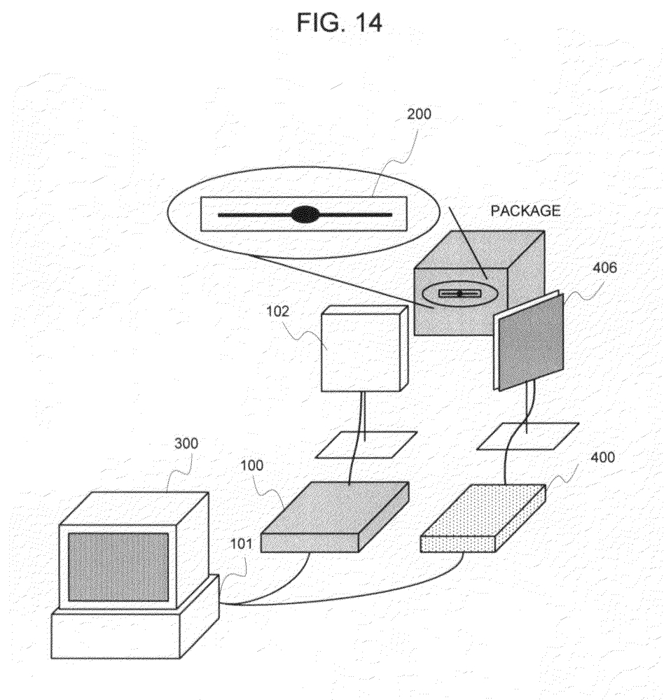

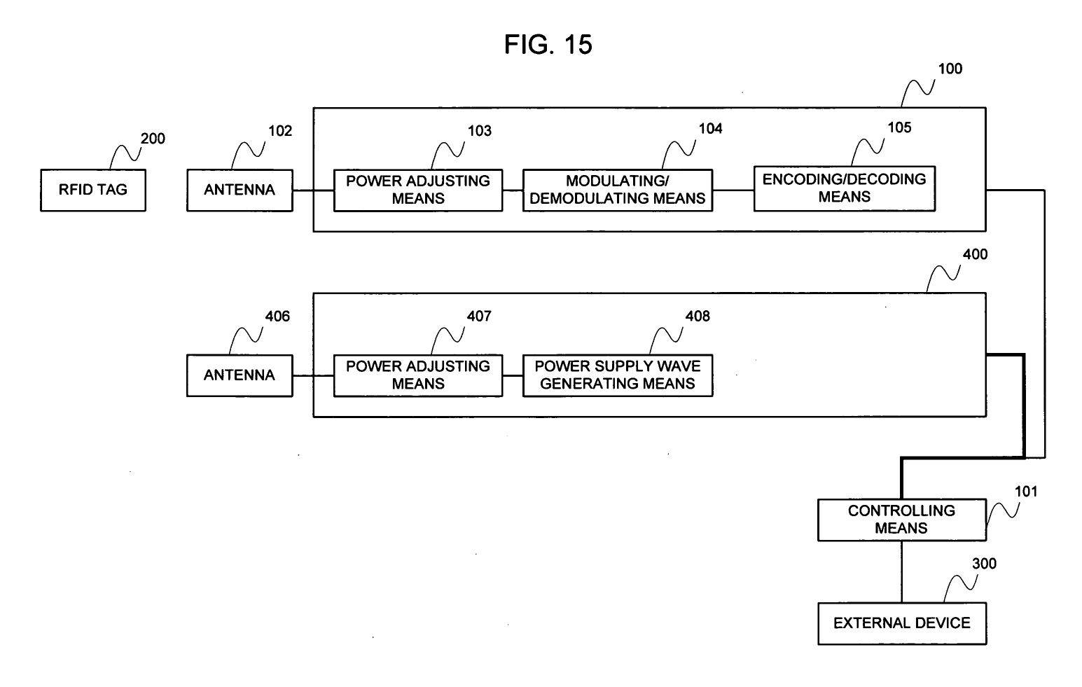

FIG. 14 is an appearance view of the RFID system in the third embodiment, and FIG. 15 is a block diagram of the RFID system in the third embodiment.

The RFID system in the third embodiment, as shown in FIG. 14, is configured of an RFID tag 200 for holding the ID attached to a package etc., receiving an interrogation wave from an antenna 102 and a power supply wave from an antenna 406, and transmitting the ID filed inside it as a response wave, a controlling means 101 for controlling an operation of each portion of a reader 100 and an power supply device 400, an external device 300 for giving an instruction to the controlling means 101, the reader 100 for transmitting the interrogation wave to the RFID tag 200, or reading off the response wave from the RFID tag 200, an antenna 102 for transmitting the interrogation wave from the reader 100, or receiving the response wave from the RFID tag 200, the antenna 406 for transmitting the power supply wave to the RFID tag 200, and the power supply device 400 for supplying the power to the RFID tag 200 through the antenna 406.

The third embodiment is an embodiment that is obtained by combining the first embodiment and the second embodiment. That is, it is characterized in transmitting the power supply wave and the interrogation wave, which are transmitted to the RFID tag 200, by changing the power of both.

Thus, the reader 100, as shown in FIG. 15, is configured of a power adjusting means 103 for adjusting the power of the interrogation wave modulated by a modulating/demodulating means 104 in addition to an encoding/decoding means 105 for generating a code, which is transmitted to the RFID tag 200, to convey it to the modulating/demodulating means 104, and yet picking up data from the demodulated signal, which is output from the modulating/demodulating means 104, based upon the instruction by the controlling means 101, and the modulating/demodulating means 104 for modulating the encoded signal from the encoding/decoding means 105 to convey it to the antenna 102, and yet demodulating the response wave from the RFID tag 200, which is output from the antenna 102, to convey it to the encoding/decoding means 105 based upon the instruction by the controlling means 101.

Further, the power supply device 400, as shown in FIG. 15, is configured of a power supply wave generating means 408 for generating a power supply wave, which is supplied to the RFID tag, based upon the instruction by the controlling means 101, and a power adjusting means 407 for adjusting an output power of the power supply wave generated by the power supply wave generating means 408.

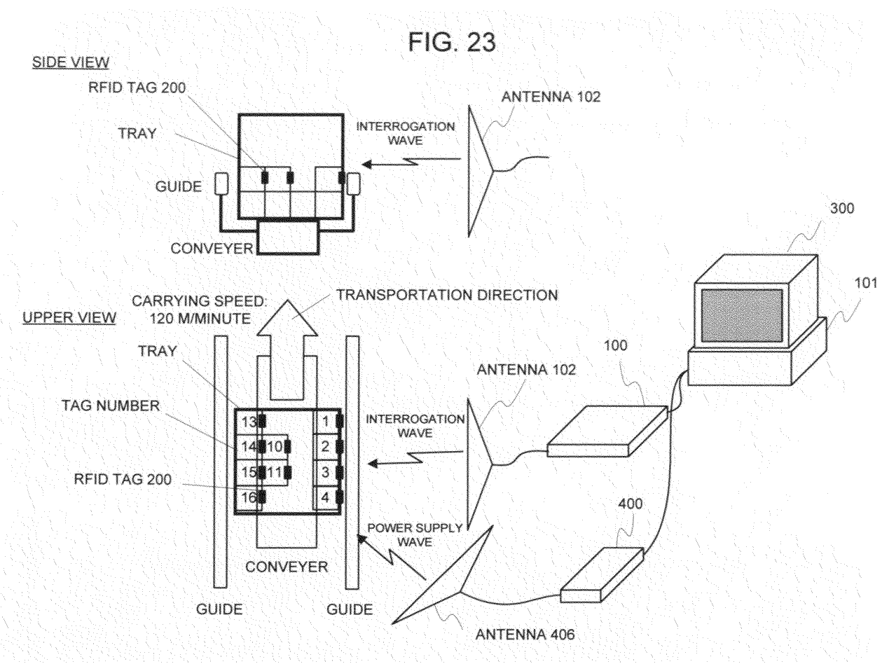

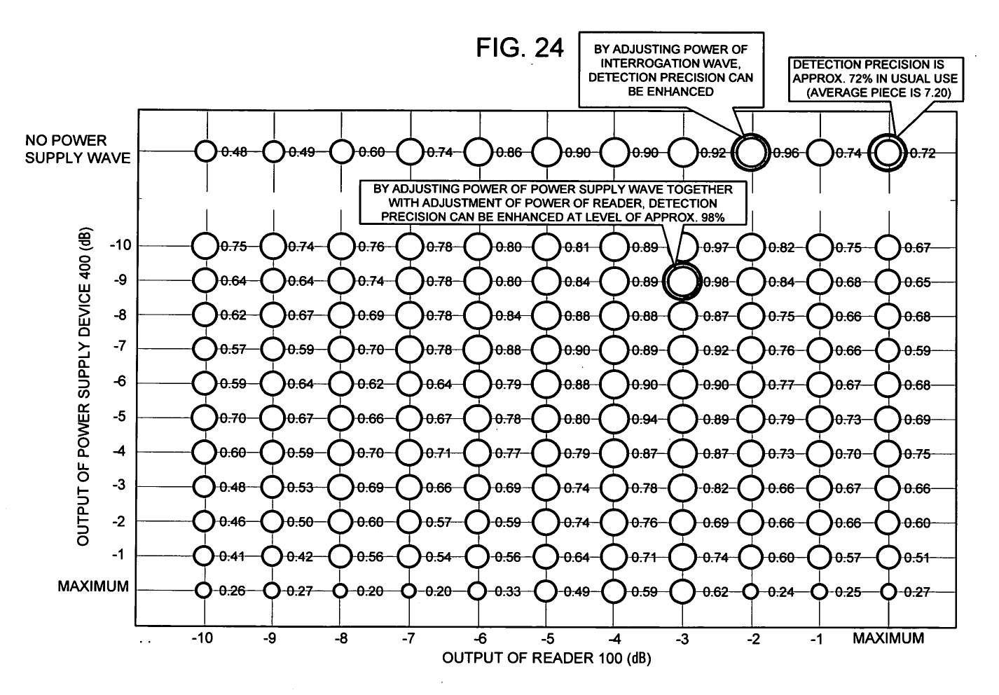

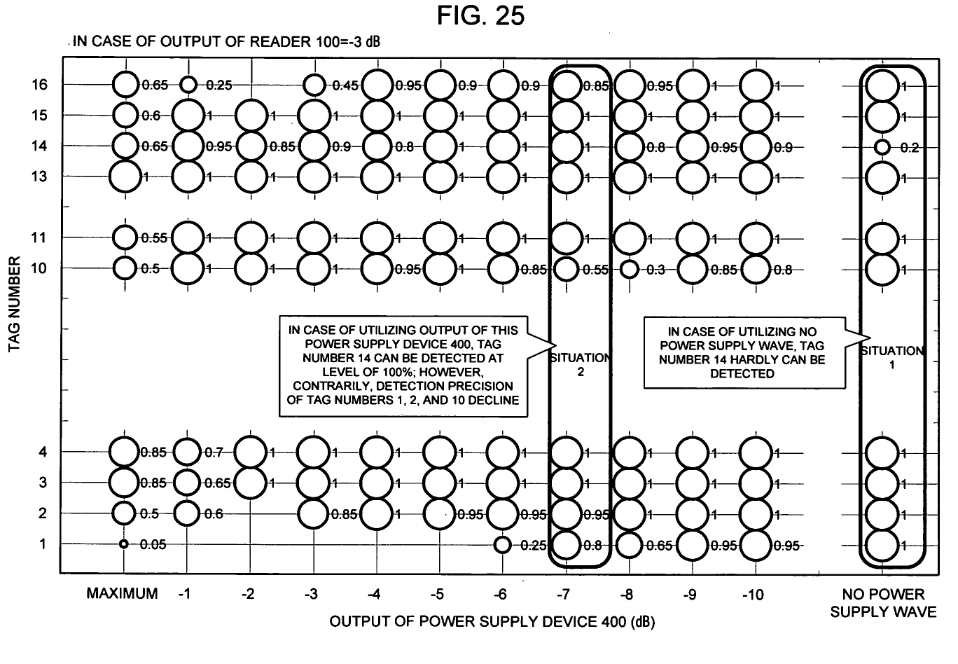

FIG. 23 is a configuration view, and each of FIG. 24 and FIG. 25 is a graph illustrating a measurement result of an experimental system for measuring a relation of a detection precision at which the reader 100 reads off the RFID tag, the output power of the reader 100, and the output power of the power supply device 400 in the case of having carried 10 RFID tags 200 fixed to an acrylic-made tray at a speed of 120 m/minute, respectively. In FIG. 23, a control line to the power supply device 400 from the controlling means 101 enables synchronization of the power supply device 400 and the reader 100.

In FIG. 24, the power of the interrogation wave being output from the reader 100, and the power of the power supply wave being output from the power supply device 400 are shown in a traverse axis, and a longitudinal axis, respectively, and a size of the circle indicates the detection precision in the situation in which each interrogation wave/each power supply wave have been combined. The power of the interrogation wave being output from the reader 100 in the traverse axis, which is a relative power with respect to the maximum output power (approx. 300 mW) from the reader 100, is expressed in a unit of dB. Further, the power as well of the power supply wave being output from the power supply device 400 in the longitudinal axis, which is a relative power with respect to the maximum output power (approx. 300 mW), is expressed in a unit of dB. The average detection precision (the number of detection for each trial/the average of the number of all tags) in the situation in which each interrogation wave/each power supply wave have been combined is described in the neighborhood of the circle.

FIG. 24 indicates that only the average detection precision of 72% or so can be obtained in the situation, which is utilized in the conventional technology, i.e. the situation in which the output of the reader 100 is maximum and yet there is no output of the power supply device 400. Further, it indicates that adjusting the output of the reader 100 enables the average detection precision to be enhanced at a level of approx. 96% or so, and furthermore, adjusting the power of the power supply wave from the power supply device 400 enables it to be enhanced at a level of approx. 98% or so. In the general radio communication technology, the larger the power, which can be utilized for communication, is, the more the performance is enhanced; however, similarly to the explanation made by employing FIG. 7, this experiment result demonstrates that the case that in the RFID system, an increase in the power of the interrogation wave or the power supply wave does not always lead to an improvement to the detection precision in the radio wave environment that is not ideal because a reflective body or an obstacle exists, for example, a factory and a laboratory occurs.

On the other hand, FIG. 25 indicates a relation of the power of the power supply wave being transmitted from the power supply device 400, the tag number of the RFID tag 200, and the detection precision of each RFID tag 200 at the time that the relative power of the interrogation wave being output from the reader 100 is −3 dB. In the traverse axis is shown the power of the power supply wave being output from the power supply device 400, being a relative power with respect to the maximum output power (approx. 300 mW) of the power supply wave being output from the power supply device 400, which is expressed in a unit of dB. The tag number affixed tray by tray, which is described in FIG. 23, is shown in the longitudinal axis. Further, the detection precision (the number of times of detections÷all number of times of trials) for each RFID tag 200 in the situation in which the power supply wave is output from each power supply device 400 is described in the neighborhood of the circle.

FIG. 25 indicates that in a case where no power supply wave from the power supply device 400 exists, the RFID tag 200 having the tag number 14 is hardly detected, and all of the other RFID tags 200 have been detected at a precision of 100%. On the other hand, in a case where it is assumed that the relative output power from the power supply device 400 is −7 dB, the tendency in which the detection precision of the RFID tag 200 having the tag number 14 became 100%, whereas the detection precision of the other tags such as the tag having the tag number 10 declined was obtained. This, similarly to the experiment result shown in FIG. 8, indicates not only that the optimum combination of the interrogation wave/the power supply wave differs tag by tag, but also that managing the detection result obtained by each combination of the powers of the interrogation wave/the power supply wave enables a high detection precision to be realized.

This embodiment, which has been accomplished in consideration of these peculiarities, is characterized in realizing a high detection precision by changing the both powers of the power supply wave and the interrogation wave, which are transmitted to the RFID tag 200, to transmit them.

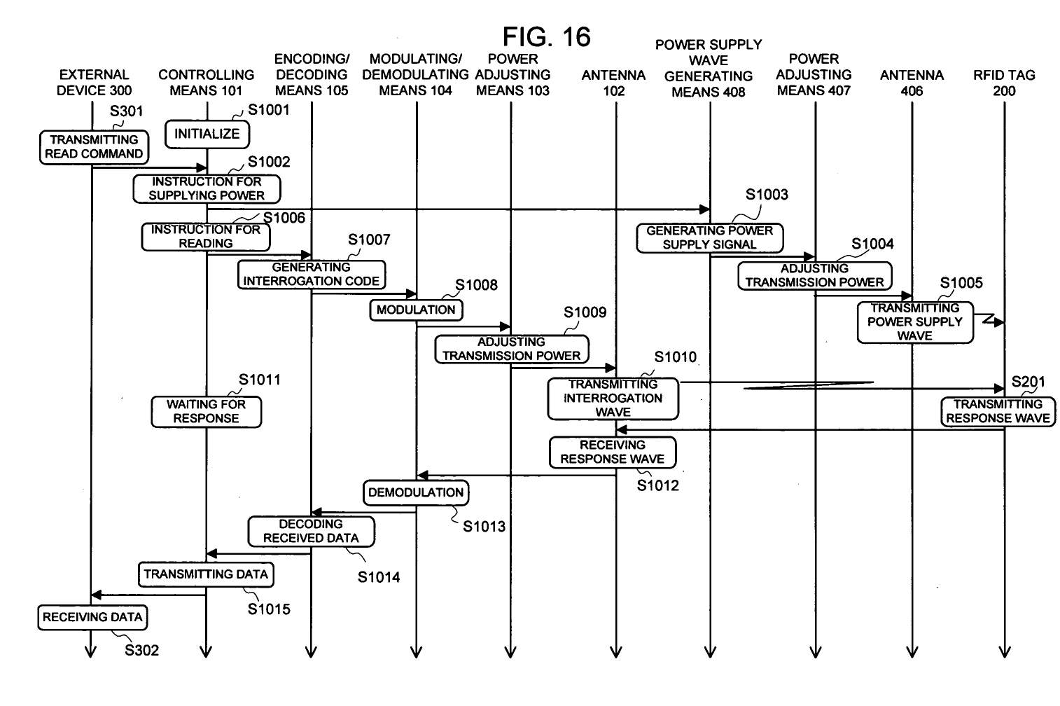

Next, a flow of the process of the third embodiment of the present invention will be explained by employing FIG. 16.

At first, after the controlling means 101 initializes the entirety of the reader 100 (S1001), it waits for a command from the external device 300. And, upon receipt of a read command from the external device 300, the controlling means 101 sends an instruction to the encoding/decoding means 105 so that the encoding/decoding means 105 generates the interrogation wave to the RFID tag (S1006).

After the encoding/decoding means 105 generates a code for a command, which is forwarded to the RFID tag, upon receipt of the instruction (S1007), and generates an interrogation wave by applying the modulation necessary for transmission, which is carried out by the modulating/demodulating means 104, hereto (S1008), it adjusts the power of this interrogation wave by the power adjusting means 103 (S1009). And the power-adjusted interrogation wave is transmitted to the RFID tag through the antenna 102 (S1010).

On the other hand, upon receipt of the instruction for supplying the power from the controlling means 101 (S1002), the power supply device 400 generates a power supply signal by the power supply wave generating wave 408 (S1003) in parallel to the transmission of the interrogation wave by the reader 100. The power supply device 400 transmits the power supply wave to the RFID tag 200 through the antenna 406 (S1005) while periodically changing the power of the power supply signal by the power adjusting means 407 (S1004). Herein, the so-called power supply wave is a carrier wave similar to the power supply portion of the interrogation wave that is successively transmitted.

The RFID tag 200 receives the interrogation wave and transmits the ID filed inside the RFID tag 200 as a response wave responding to the superposed code for a command (S201).

Upon receipt of the response wave from the antenna 102 (S1012), the reader 100 executes each of the demodulating process by the modulating/demodulating means 104, and the decoding process by the encoding/decoding means 105 (S1013 and S1014), picks up the ID, which is included in the response wave, as data, and transmits it to the external device 300 (S1015).

The external device 300 executes a displaying process, a computing process, etc. based upon the data received from the reader 100 (S302).

The controlling means 101 repeats the process of the step S1002 and the step after it and continues to execute the ID reading process of the RFID tag 200 until it receives an instruction for interrupting the process from the external device 300. During this time, the power supply device 400 continues to supply the power supply wave to the RFID tag 200 while changing the power of the power supply wave.

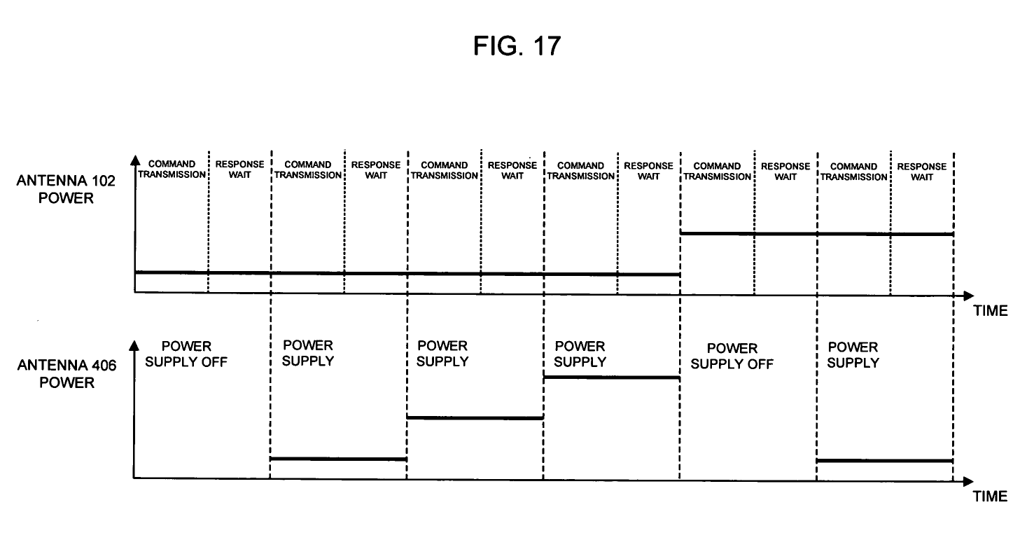

FIG. 17 is a view for explaining an operation of the third embodiment of the present invention.

The lower stage of FIG. 17 indicates that the operation in which the power supply wave being transmitted to the RFID tag 200 from the antenna 406, of which the power augments in an ascending order, beginning with the situation of the power supply off, is supplied is repeated. At this time, as shown in the upper stage of FIG. 17, a configuration is made so that the operation in which the magnitude as well of the power of the interrogation wave being transmitted from the antenna 102 changes in an ascending order at a timing at which an operation of the power supply wave takes a round is repeated.

The portion other than the foregoing is identical to that of the first embodiment and the second embodiment of the present invention, so its explanation is omitted.

Next, an effect of the embodiment of the present invention will be explained.

This embodiment is characterized in outputting both of the interrogation wave and the power supply wave while changing their magnitudes. It is thinkable that the power of the power supply wave, which the tag receives from the power supply device 400, and the power of the interrogation wave, which the tag receives from reader 100 changes depending upon the position and the posture of the tag. FIG. 9 indicates that also in a case where the magnitude of the power supply wave or the interrogation wave received by the tag is not optimum for detection due to such influences of the position and the posture, executing an read operation while periodically changing both the magnitudes of the interrogation wave and the power supply wave makes it possible to enhance the detection precision.

In the third embodiment of the present invention, similarly to the first embodiment and the second embodiment, periodically changing the powers of the interrogation wave and the power supply wave in such a manner makes it possible to eliminate influences of the position and the posture of the RFID tag, and to produce the power supply condition optimum for each RFID tag at least once. Additionally, it is similar to the first embodiment and the second embodiment that a step number, a period, and a change pattern of the powers of the interrogation wave and the power supply wave should be set responding to the reader being utilized, and the surrounding environment. The other effect is similar to that of the first embodiment and the second embodiment, its explanation is omitted.

### Fourth Embodiment

A fourth embodiment of the present invention will be explained in details by making a reference to the accompanied drawings.

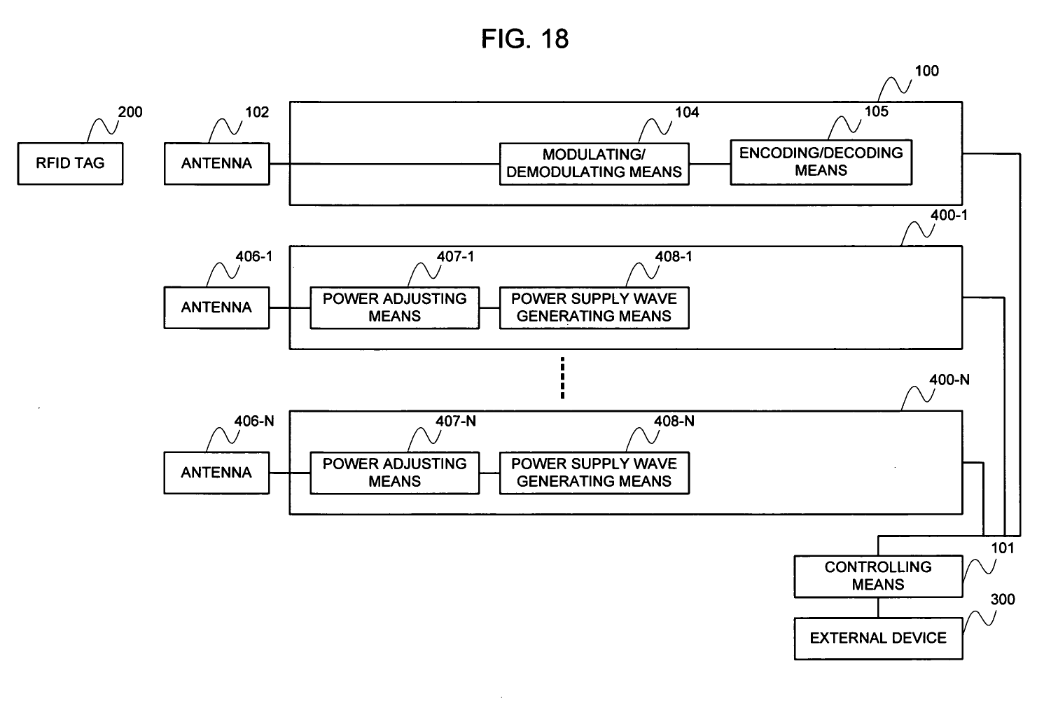

FIG. 18 is a block diagram of the RFID system in the fourth embodiment.

The RFID system in the fourth embodiment, as shown in FIG. 18, is characterized in mounting the power supply device 400 and the antenna 406 of the first embodiment in plural.

Power supply devices 400-1 to 400-N are connected to antennas 406-1 to 406-N, respectively. The power supply devices 400-1 to 400-N are configured of power supply wave generating means 408-1 to 408-N for generating a power supply wave, which is supplied to the RFID tag, based upon the instruction by the controlling means 101, and power adjusting means 407-1 to 407-N for adjusting an output power of the power supply wave generated by the power supply wave generating means 408-1 to 408-N, respectively, and each means has a configuration similar to that of the foregoing first embodiment. Thus, the power supply wave generating means 408-1 to 408-N, as shown in FIG. 18, transmit respective power supply waves to the RFID tag 200 through the antennas 406-1 to 406-N while changing the power of the power supply wave, respectively. Additionally, a plurality of the power supply devices are mounted differently to the first embodiment, whereby with the instruction by the controlling means 101, an operation of any power supply device may be stopped, and the output timing or the power of the power supply wave being output from each of the power supply devices 400-1 to 400-N may be controlled so that it differs for each power supply device.

By periodically changing the powers of a plurality of the power supply waves by making a configuration in such a manner, it becomes possible to furthermore eliminate influences of the position and the posture of the RFID tag than the first embodiment does, and to surely produce the power supply condition optimum for each RFID tag at least once.

### Fifth Embodiment

A fifth embodiment of the present invention will be explained.

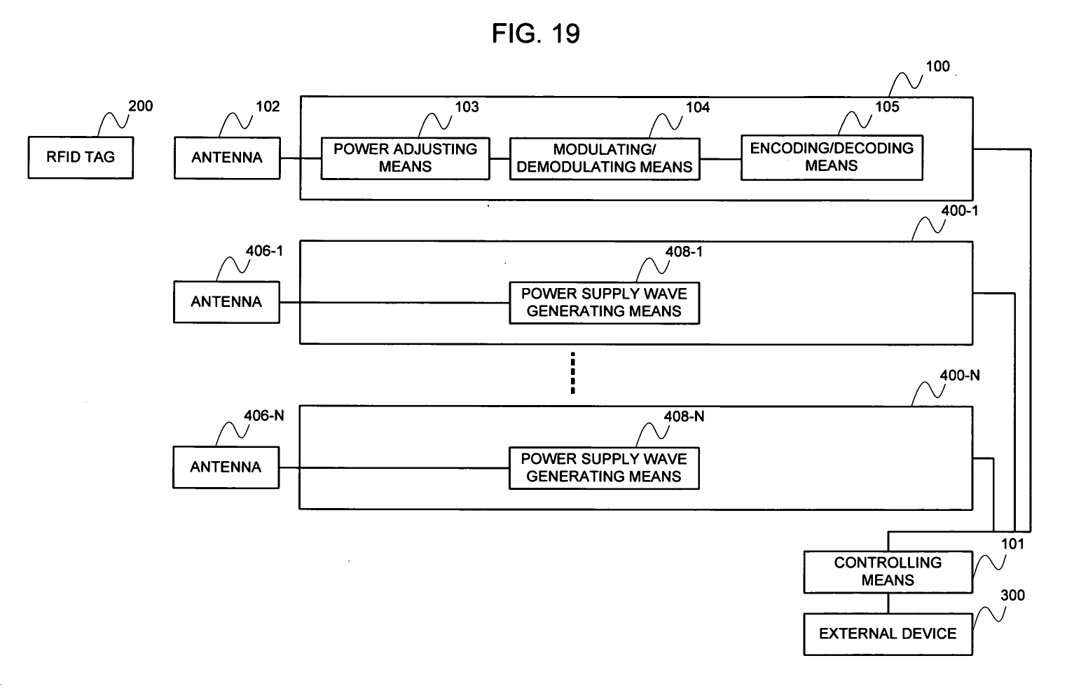

FIG. 19 is a block diagram of the RFID system in the fifth embodiment.

The second embodiment includes only one power supply device 400 for transmitting the power supply wave to the RFID tag 200, and the fifth embodiment, as shown in FIG. 19, is characterized in mounting the power supply device 400 and the antenna 406 in plural. On the other hand, the fifth embodiment is similar to the second embodiment in a point of changing the power of the interrogation wave, which is transmitted to the RFID tag 200.

Power supply devices 400-1 to 400-N are connected to antennas 406-1 to 406-N, respectively. The power supply devices 400-1 to 400-N include power supply wave generating means 408-1 to 408-N for generating a power supply wave, which is supplied to the RFID tag, based upon the instruction by the controlling means 101, respectively, and each means has a configuration similar to that of the foregoing first and second embodiments. Additionally, a plurality of the power supply devices are mounted differently to the second embodiment, whereby with the instruction by the controlling means 101, an operation of any power supply device may be stopped, and the output timing of the power supply wave being output from each of the power supply devices 400-1 to 400-N may be controlled so that it differs for each power supply device.

### Sixth Embodiment

A sixth embodiment of the present invention will be explained.

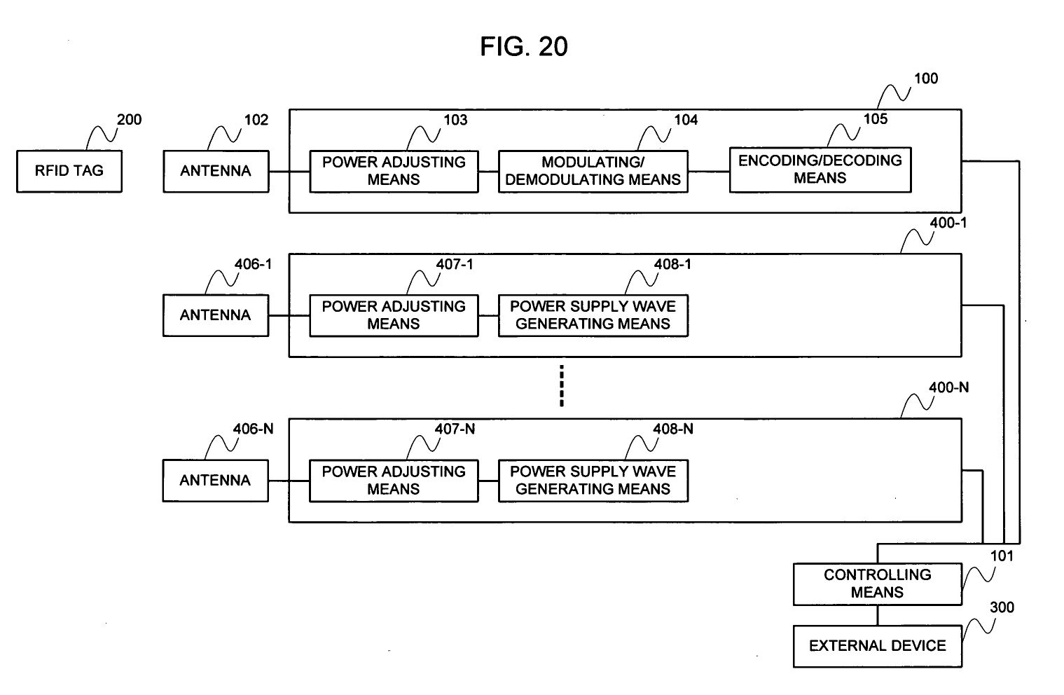

FIG. 20 is a block diagram of the RFID system in the sixth embodiment.

The sixth embodiment, which includes a reader 100, an antenna 102, a plurality of antennas 406, and a plurality of power supply devices 400, is characterized in being an embodiment that is obtained by combining the second embodiment and the fifth embodiment.

Thus, the sixth embodiment, as shown in FIG. 20, includes the reader 100 and the antenna 102, which are similar to that of the second embodiment, and a plurality of antennas 406-1 to 406-N and a plurality of power supply devices 400-1 to 400-N, which are similar to that of fourth embodiment.

By periodically changing the powers of the reader and a plurality of the power supply waves by making a configuration in such a manner, it becomes possible to furthermore eliminate influences of the position and the posture of the RFID tag than the other embodiments do, and to surely produce the power supply condition optimum for each RFID tag at least once.

### Example 1

An example 1 will be explained.

The example 1 is a specific example that corresponds to the first embodiment, and a specific example of the system shown in FIG. 1.

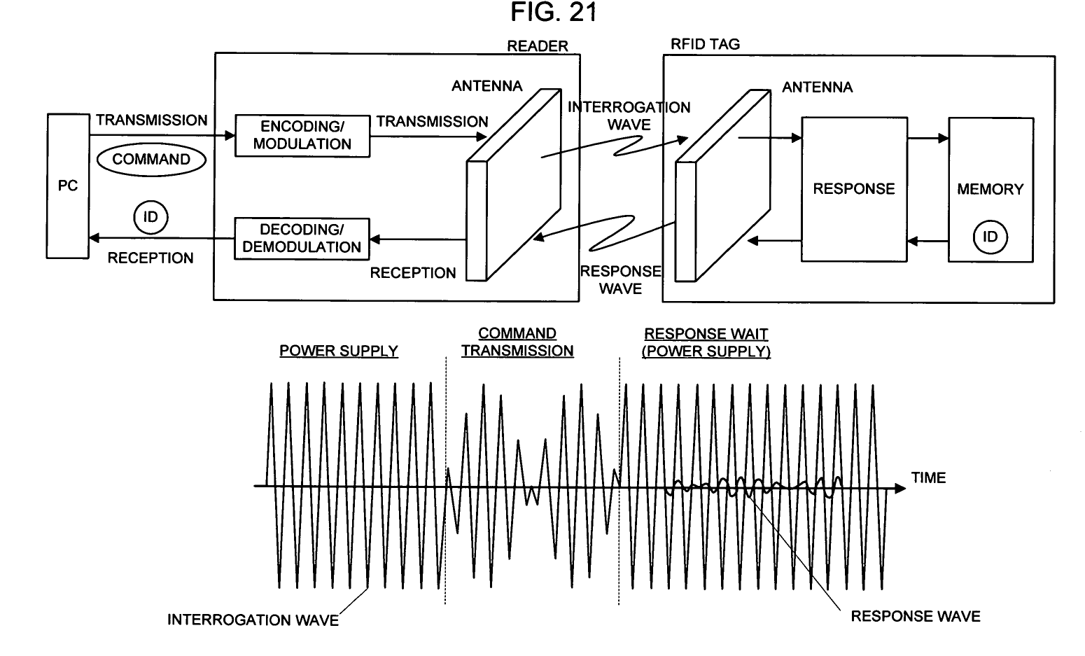

The RFID tag 200, being an object of detection, is attached to the package. The RFID tag 200, as shown in the upper side of FIG. 21, is a tag obtained by inserting a circuit, which is configured of an antenna and an IC chip having functions of a response processing section and a memory section, into a resin etc. Herein, the RFID system in which the radio wave of 2.4 GHz called a microwave band is assumed to be a carrier wave will be explained; however this does not limit an object of application of the present invention. The present invention is applicable to the entirety of the technique in which the transmission and reception of energy by means of the electromagnetic wave are involved, for example, the RFID system adopting the other band including a band of 860 MHz to 930 MHz.

The RFID tags having various antennas or assuming various shapes are realized, and herein, the RFID tag utilizing a die pole antenna, of which the size is approx. 7 cm or so, being a half of the wavelength of the carrier wave, will be explained; however the present invention is applicable to all RFID tag irrespectively of the shape of the RFID tag or the class of the antenna.

The reader 100 include a small-size plane antenna 102 for transmitting an interrogation wave/receiving a response wave and the power supply device 400 includes a small-size plane antenna 406 for supplying a power, and the antenna 102 and the antenna 406 are arranged so that the former faces the package frontally and the latter faces the package obliquely, respectively.

In this example 1, the controlling means 101 is realized as software over the PC, being the external device 300. This does not limit an application of the present invention, and it can be configured of a program for controlling a central processing unit (CPU) and the reader 100.

The reader 100, which is connected to the external device 300 onto which the controlling means 101 has been installed via a serial line, is configured so that it can make data communication with the controlling means 101.

Next, a specific operation of the RFID system in the example 1 will be explained by making a reference to FIG. 3.

The controlling means 101 initiates the control according to a pre-decided procedure when software is started, and executes an initialize necessary for the controlling means 101 itself and the reader 100 (S1001).

Next, upon receipt of one-byte data (40 by the hexadecimal number) indicating “a read command” from a user through the PC, being the external device 300, the controlling means 101 gives an instruction for staring a read operation of the RFID tag to the reader 100 (S301).

Upon receipt of the read command from the controlling means 101, the reader 100 controls each section so that it reads off the ID of the RFID tag 200 (S1006). That is, after the controlling means 101 generates an interrogation code for a four-byte data row obtained by adding a preamble of three bytes (555555 by the hexadecimal number) to a one-byte command (80 by the hexadecimal number) for requesting the RFID tag 200 to transmit the ID by use of the encoding/decoding means 105 (S1007), and prepares an interrogation wave by applying the modulation by the carrier wave to the interrogation code, it amplifies it so that its power is a constant power value (S1008), and transmits it to the RFID tag 200 through the antenna 102 (S1010). At this time, the encoding/decoding means 105 prepares the interrogation code with a Manchester code, and the modulating/demodulating means 104 executes the modulation by adopting an Amplitude Shift Keying (ASK). Additionally, these, which are set only for explanation, do not limit an application scope of the present invention.

Thereafter, the controlling means 101 comes into a situation of waiting for a response wave from the RFID tag (S1011).

On the other hand, the power supply device 400 generates a power supply signal by the power supply wave generating means 408 (S1003) in parallel to the transmission of the interrogation wave by the reader 100. That is, the power supply wave generating means 408 generates a carrier wave having a designated frequency (S1003), the power adjusting means 407 amplifies the signal generated by the power supply wave generating means 408 while periodically changing an amplification ratio of the amplifier (S1004), and the power supply wave is transmitted to the RFID tag 200 affixed to the package from the antenna 406 (S1005). The method of generating such a carrier wave and the method of amplifying the power by the amplifier is a general technology, respectively, so its details are omitted. Any of the methods, which are able to generate a signal that is effective as a power supply wave for the RFID tag, is acceptable.

In such a manner, the example 1 is characterized in that the interrogation wave is provided successively from the antenna 102, and the reader 100 repeatedly comes into the situation of transmitting the command and waiting for the response transmission for execution, whereas the power supply wave is supplied from the antenna 406 while the power thereof is changed.

Only the interrogation wave is transmitted by employing the single antenna 102 in the conventional technology, whereby the ID of the RFID tag 200 cannot be read off in a case where a positional relation between the RFID tag 200 and the antenna 102 comes in a situation of being oblique, or in a case where the sufficient power cannot be supplied to the RFID tag 200 due to an obstacle.

For example, as described in the explanation of the first embodiment, in a case where the RFID tags in a box, which is put on a belt conveyer and migrates, as shown in the left side of FIG. 5, assumes various postures, it follows that the undetectable RFID tag is generated depending upon the distance from the antenna transmitting the interrogation wave or the posture of the RFID tag. Even though the posture of the antenna is changed, it is difficult for the antenna to assume an excellent posture for all of the RFID tags, and besides, the antenna posture is changed whenever the position/posture of the RFID tag in a box changes, whereby there is the possibility that the RFID tag, which cannot be detected by each antenna, still exists.

The technology as well of decreasing such undetectable RFID tags by supplying each of the interrogation wave and the power supply wave from a different antenna has been proposed; however the excess/shortage of the power to the RFID tag is generated due to a positional relation between the RFID tag and each of the antenna for supplying a power and the antenna for an interrogation wave, and hence the RFID tags are not all read off because the interrogation wave and the power supply wave are forwarded with their magnitudes fixed.

The present invention is characterized in that, as shown in the right side of FIG. 5, transmitting the interrogation wave to the RFID tag (executes a read operation), and simultaneously therewith, transmitting the power supply wave from the another antenna while changing its magnitude allow the sufficient power to be supplied to the RFID tag, and the detection precision of the RFID tag to be enhanced. That is, as shown in the lower side of FIG. 4, the power supply wave being transmitted to the RFID tag 200 from the antenna 406, of which the magnitude of the power augments in an ascending order, beginning with the situation of the power supply off, is supplied, on the other hand, the interrogation wave is successively provided from the antenna 102 of the reader 100, and the reader 100 repeats the situation of transmitting the command and waiting for the response for execution.

It is as described in the explanation of the first embodiment of the present invention that periodically changing the power of the power supply wave in such a manner makes it possible to eliminate influences of the position and the posture of the RFID tag, and to surely produce the power supply condition optimum for each RFID tag at least once.

Additionally, this example is configured so that this operation of changing the power of the power supply wave is performed asynchronously with the read operation utilizing the antenna 102, i.e. the timing at which the magnitude is changed is different from a total time of the command transmission and the response wait.

Further, four stages of the situation of the power supply being stopped, a small magnitude, a middle magnitude and a large magnitude are utilized as a magnitude. These, which are set only for explanation, do not limit an application scope of the present invention. The period of the read operation and the period at which the power of the power supply wave is changed are changeable responding to the utilization environment etc. For example, in a case where the time for necessary for changing the power of the power supply wave is longer as compared with that of the one-time read operation, a configuration can be made so that the read operation is successively performed with it being still asynchronous with the operation of changing the power of the power supply wave.

Further, in a case where the time for necessary for changing the power of the power supply wave is almost identical to that of the one-time read operation, a configuration also can be made so that the operation of changing the power of the power supply wave is performed synchronously with the read operation by the reader 100 according to the instruction by the controlling means 101. In addition hereto, the stage number as well of the power of the power supply wave, which is not limited to four, can be changed responding to dissolution of the amplifier being utilized or the utilization environment.

Continuously, the operation will be explained.

The RFID tag 200 supplies the power to the circuit by utilizing the carrier waves of the interrogation wave and the power supply wave, and gives the ID on the memory as a reply upon confirming the interrogation code within the received interrogation wave. For example, in a case where the ID is expressed as 1234 with the hexadecimal number of two bytes, the RFID tag prepares a response code row obtained by adding the preamble of three bytes hereto, prepares a response wave including the response code row by utilizing a reflection component of the carrier wave, and transmits it (S201). The encoding method and the modulation method identical to that of the reader 100 are employed as an encoding method and a modulation method at this time.

The demodulating process (S1013) and the decoding process (S1014) are applied for the response wave input into the reader 100 from the antenna 102 (S1012) by the modulating/demodulating means 104 and by the encoding/decoding means 105, respectively, and the ID is picked up.

The reader 100 transmits the picked-up ID (1234) to the controlling means 101 via the serial line.

The controlling means 101 displays the ID of the RFID tag by displaying the ID (1234) received from the reader 100 on the display connected to the PC, being the external device 300.

Additionally, in this example, the explanation was made on the premise that the plane antenna was utilized; however any of the antennas, which are utilizable for the passive-type RFID, can be utilized.

Further, in this example, it was assumed that by adopting the serial line, the connection between the PC and the reader was made for data communication; however, needless to say, the other communicating means such ETHERNET (Registered Trademark) can be utilized.

In addition hereto, in the above-mentioned explanation, a configuration was made so that transmitting a command from the PC to the controlling means 101 triggered the read operation by the reader 100; however a configuration can be made so that after a power supply of the controlling means 101 and the reader 100 is started, and the initialize necessary is finished, the read operation is automatically started, and the obtained ID is forwarded to the PC.

Further, the command, which is utilized between the PC and the controlling means 101, and between the controlling means 101 and the reader 100, is not restricted by the above-mention explanation, and any of the commands, which both can identify mutually, is acceptable.

Likewise, with the interrogation code, the response code, the modulation/demodulation method, and the encoding/decoding method, which the reader 100, the power supply device 400, and the RFID tag 200 utilize, the techniques thereof, which are utilizable for the general passive-type RFID system, can be all utilized.

Additionally, this example is similarly applicable to the foregoing second embodiment to sixth embodiment.

### Example 2

An example 2 of the present invention will be explained. The example 2 is an example of having applied the first embodiment of the present invention for a portable reader.

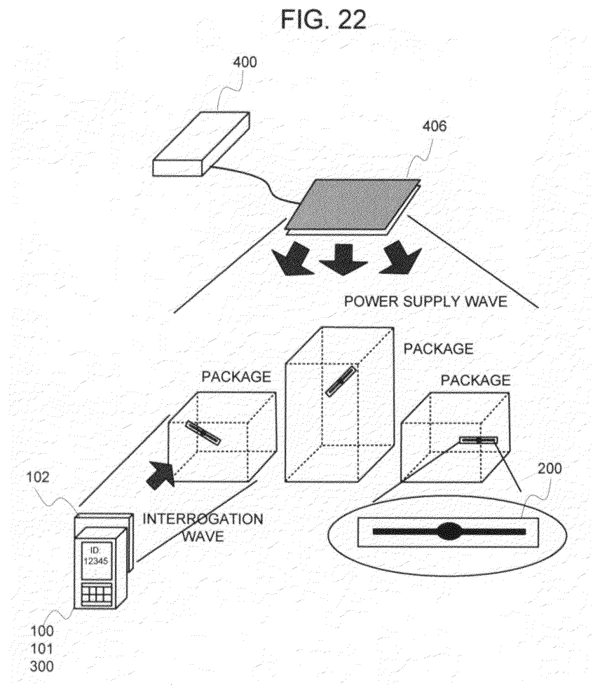

In FIG. 22, a portable reader 100 is integrated into a controlling means 101 and a small-size computer, being the external device 300, together with an antenna 102 for configuration. The small-size computer 300 is provided with a liquid screen for presenting information to the user, and a keypad for inputting an instruction from the user. The controlling means 101 is packaged as software over the small-size computer 300. Further, the small-size computer 300, the controlling means 101, and the portable reader 100 are all configured to utilize a small-size battery as a power source for operation for aiming at making each of them available during migration in a warehouse.

On the other hand, a configuration is made so that the antennas 406 connected to the power supply device 400 are attached to the upper portion of a plurality of packages put within in a warehouse and the power supply wave are supplied to all of the packages.

The user reads off the ID of the RFID tag 200 being included in each package while holding up the antenna 102 of the portable reader 100 over a plurality of the packages that exist in a warehouse, thereby to confirm the kind and the number of goods (not shown in FIG. 22) having the RFID tag 200 attached that exist in the package.

An operation of each section is similar to a flow of the process of the example 1 that corresponds to the first embodiment. That is, when the user forwards an instruction for executing the reading of the tag from the keypad of the small-size computer 300 to the controlling means 101, the controlling means 101 transmits an interrogation wave from the antenna 102 connected to the portable reader 100. When the RFID tag 200 receives both of the power supply wave from the antenna 406 connected to the power supply device 400 attached to the upper portion of the package, and the interrogation wave from the antenna 102, it interprets its content, and transmits a response wave including its own ID. The portable reader 100 receives the response wave from the RFID tag 200, and extracts the ID. The extracted ID is displayed on the liquid display device of the small-size computer 300 together with a name of the good having the corresponding ID retrieved from a database within the device.

Usually, in a case of driving the portable reader 100 with the battery, the power being output from the antenna 102 has to be lessened whenever possible for aiming at prolonging the workable time. Lessening the power of the interrogation wave, however, incurs a decline in a read performance of the portable reader 100 itself, and leads to an increase in the event that the RFID tag 200 inside the package cannot be read off when the position or the posture of the RFID tag 200 are changing in a diversified way.

Further, also in a case of having enlarged the power of the interrogation wave, the problem that not only the available time of the battery is shortened, but also data of the RFID tag 200 in the neighboring package is read off occurs sometimes.

On the other hand, in the example 2 of the present invention, it is enough that the power necessary for the operation of the RFID tag 200 is considered by bracketing the power supply wave from the antenna 406 connected to the power supply device 400 and the interrogation wave being transmitted from the portable reader 100, whereby the power of the interrogation wave can be lessened. It becomes possible not only to prolong the battery duration time of the portable reader 100, but also to lessen the interrogation wave at an extent at which the RFID tag 200 in the other package is not read off erroneously. It is as described in the explanation of the first embodiment that the fact as well that the RFID tag 200 can be detected by the portable reader 100 at a high precision without being influenced by the posture and the position of the RFID tag 200 existing within each package because the magnitude of the power supply wave being supplied from the power supply device 400 is changed at this time is one great characteristic of the present invention.

The portion other than the foregoing is identical to that of the example 1 of the present invention, so its explanation is omitted.

Above, the embodiment and the example were explained, and in the explanation, the power supply device was described as another device having a configuration different from that of the reader for a purpose of making the understanding easy; however, needless to say, even though a configuration is made so that a plurality of the readers are prepared, and one part thereof is utilized for causing it to play a role as a power supply device, the present invention is applicable hereto.

### Example 3

An example 3 will be explained.

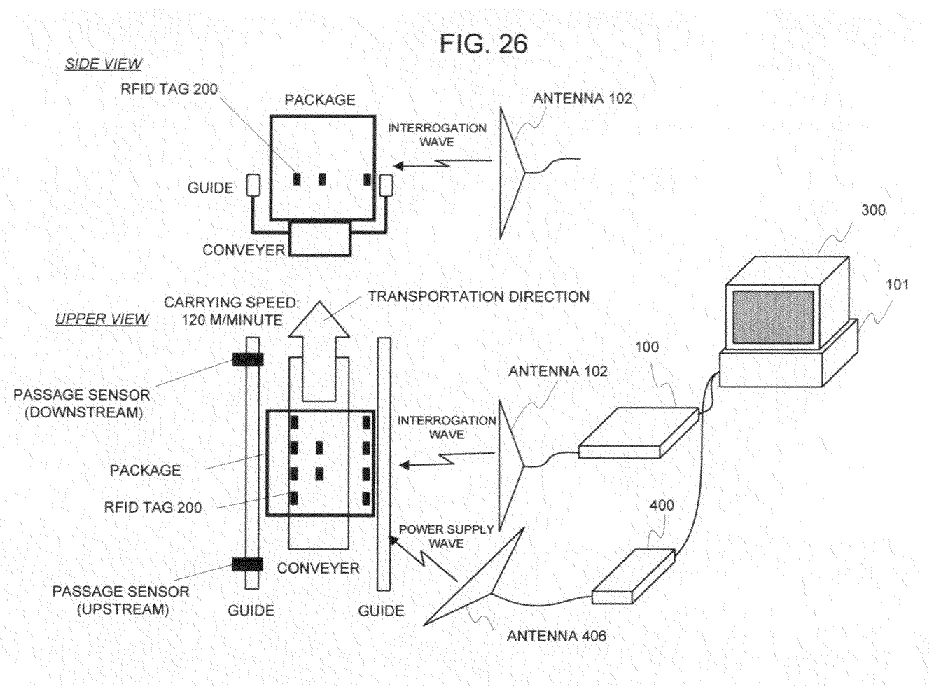

The example 3 is a specific example that corresponds to the third embodiment, and a specific example of the system that is shown in FIG. 14. The appearance of this example is shown in FIG. 26. This example is an example of having envisaged a part management at a production line etc. in a factory.

The example 3, as compared with example 1, differs from in a point that a plurality of the RFID tags 200 are included in the package, the package is in a situation of being carried by a conveyer at a speed of 120 m/minute, the power supply device 400, which is connected to the PC, being the external device 300, via the serial line, is controllable by the controlling means 101 similarly to the reader 100, and intrusion/exit of the package on the conveyer into/from the facade of the antenna 102 is detectable by a passage sensor connected to the PC, being the external device 300.

The operation in the example 3 is configured of, in a step S301 described in FIG. 16, a step in which the PC, being the external device 300, starts the read operation by detecting that the package has come near to the facade of the antenna 102 from an output of the passage sensor mounted on the upstream side with respect to a carrying direction, and a step in which it stops the read operation by detecting that the package has passed through the facade of the antenna 102 from an output of the passage sensor in the downstream side. Such a passage sensor can utilize a general technology such as a combination of a photodiode and an LED, and a pyroelectric sensor.

Further, it is assumed that similarly to the “read command” in the example 1, the stage number of “transmission power adjustment” of the power supply by the reader 100 can set to 256 with a one-byte command (50 by the hexadecimal number) and one-byte data (by the hexadecimal number) that is transmitted in consecution hereto. A configuration is made so that by assuming that no radio wave is output at the time that data is 0, and changing the output at the time that data is 255 to at most 1, the relative power is changed continuously from 0 dB to −20 dB. The function of adjusting the output power by forwarding such a command and data is a general function, so its details are omitted. Additionally, the data format or the command, which are utilized between the PC and the passage sensor, between the PC and the controlling means 101, and between the controlling means 101 and each of the reader 100 and the power supply device 400, is not restricted by the above-mentioned explanation, and any of it is acceptable so long as it is mutually recognizable by both.

In this example 3, it is assumed that the situation of an arrangement of the RFID tag 200 being included in the package is almost identical to that of the tray and the RFID tag 200 adopted in FIG. 23, and a large change hardly exists. This premise is appropriate for a production line etc. in a factory, which this example envisages.

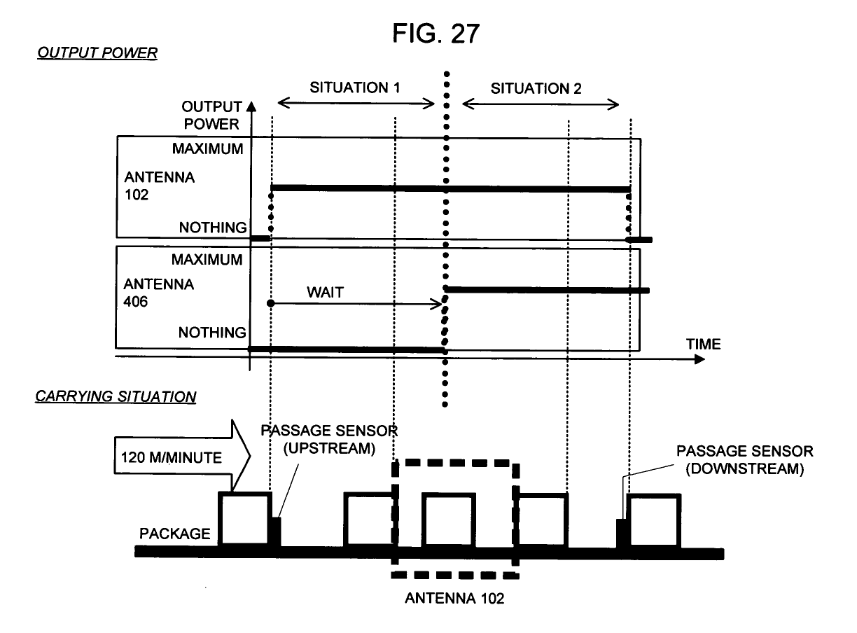

FIG. 27 is a view for explaining how the controlling means 101 controls the output power of the reader 100 and the outputs from the antenna 102 and the antenna 406 connected to the power supply device 400 in this example. The controlling means 101 utilizes two situations shown with an ellipse in FIG. 25 by making a switchover thereof, that is,

Situation 1: the relative power of the interrogation wave being output from the antenna 102 is −3 dB and yet no power supply wave is output from the antenna 406.

Situation 2: the relative power of the interrogation wave being output from the antenna 102 is −3 dB and yet the relative power of the power supply wave being output from the antenna 406 is −7 dB.

The controlling means 101 makes this switchover by making a reference to a timer inside it. When the controlling means 101 detects in a step S301 that the output of the upstream-side passage sensor has changed, it controls the reader 100 and the power supply device 400 so that the situation 1 is attained, and simultaneously therewith, resets the inside timer to start a time measurement. And, the controlling means 101 monitors the value of the timer, and transmits the command and the data to the reader 100 and the power supply device 400 so that the situation 2 is attained when the package has come near to the center of the antenna 102. Herein, the distance from the upstream-side passage sensor to the center of the antenna is 1 m, and the carrying speed is 120 m/minute, whereby the setting is made so that a switchover to the situation 2 from the situation 1 is made at a time point that 1000 ms elapses after the status of the upstream-side passage sensor changes. Needless to say, the distance and the value of the timer, to which a reference is made, like these are only exemplified, and does not restrict an application scope of the present invention.

Combining only the situation 1 and the situation 2 for utilization makes it possible to realize a high detection precision with regard to all RFID tags 200 notwithstanding a high carrying speed.

Additionally, even in a case where the arrangement of the RFID tag 200 being included in the package differs from that of the tray and the RFID tag 200 adopted in FIG. 23, if a fluctuation in the arrangement and the posture is small, it becomes possible to realize a detection precision similar to that of this example by obtaining the optimum situation by making an experiment similar to the experiment shown in FIG. 23.

Additionally, also in a case where a fluctuation in the arrangement/the posture is large, if the read operation is executed with respect to all combinations of the output powers of the interrogation wave/the power supply wave upon having made the carrying speed slow, or having stopped the package at the front of the antenna 102, the high detection precision can be realized, and the effect in the present invention is fully can be attained.

The point other than the foregoing is identical to that of the example 1, so its explanation is omitted. Additionally, this example is applicable to the foregoing fourth embodiment to sixth embodiment similarly.

1. An RFID system, an interrogation wave being transmitted to an RFID tag and a power supply wave being transmitted to the RFID tag while changing a power of at least one of them.

2. The RFID system according to claim 1, further comprising:
means for periodically changing the power of one of the interrogation wave being transmitted to the RFID tag and the power supply wave being transmitted to the RFID tag.

3. The RFID system according to claim 1, wherein the interrogation wave being transmitted to the RFID tag and the power supply wave being transmitted to the RFID tag by changing the power of one of them in a descending order.

4. The RFID system according to claim 1, wherein the interrogation wave is transmitted to the RFID tag and the power supply wave is transmitted to the RFID tag by changing the power of one of them in an ascending order.

5. An RFID system, comprising:
a reader comprising an interrogation wave power adjusting means for adjusting a power of an interrogation wave being transmitted to an RFID tag, and a transmitting means for transmitting the power-adjusted interrogation wave to the RFID tag;
a power supply device comprising a power supply wave power adjusting means for adjusting a power of a power supply wave being transmitted to an RFID tag, and a transmitting means for transmitting the power-adjusted power supply wave to the RFID tag; and
a controlling means for controlling at least one of said interrogation wave power adjusting means and said power supply wave power adjusting means, which transmits the wave while changing its power.

6. The RFID system according to claim 5, wherein said controlling means changes the power periodically.

7. The RFID system according to claim 5, wherein said controlling means changes the power in a descending order.

8. The RFID system according to claim 5, wherein said controlling means changes the power in an ascending order.

9. A reader in an RFID system, comprising:
a power adjusting means for changing a power of an interrogation wave being transmitted to an RFID tag; and a transmitting means for transmitting the power-adjusted interrogation wave to the RFID tag.

10. The reader according to claim 9, further comprising a controlling means for controlling a power adjustment of said power adjusting means.

11. The reader according to claim 10, wherein said reader is a portable reader.

12. A power supply device of an RFID system, comprising:
a power adjusting means for adjusting a power of a power supply wave being transmitted to an RFID tag; and
a transmitting means for transmitting the power-adjusted power supply wave to the RFID tag.

13. The power supply device according to claim 12, further comprising a controlling means for controlling a power adjustment of said power adjusting means.

14. A computer readable medium having a control program of an RFID system, wherein, when executed by an i.p.d., causing the information processing device to execute a process of changing a power of at least one of an interrogation wave being transmitted to an RFID tag, and a power supply wave being transmitted to an RFID tag.

15. The computer readable medium according to claim 14, wherein that the process of changing the power is a process of periodically changing the power.

16. The computer readable medium according to claim 14, wherein the process of changing the power is a process of changing the power in a descending order.

17. The computer readable medium according to claim 14, wherein the process of changing the power is a process of changing the power in an ascending order.

18. A power supply method of supplying a power to an RFID tag, comprising:
transmitting an interrogation wave to an RFID tag and a power supply wave to the RFID tag while changing a power of at least one of them.

19. The power supply method according to claim 18, further comprising:
periodically changing the power of one of the interrogation wave being transmitted to the RFID tag and the power supply wave being transmitted to the RFID tag.

20. The power supply method according to claim 18, transmitting the interrogation wave being transmitted to the RFID tag and the power supply wave being transmitted to the RFID tag by changing the power of one of them in a descending order.

21. The power supply method according to claim 18, further comprising:
transmitting the interrogation wave being transmitted to the RFID tag and the power supply wave being transmitted to the RFID tag by changing the power of one of them in an ascending order.
